(19) United States
(12) Patent Application Publication
(10) Pub. No.: US 2018/0007667 A1
(43) Pub. Date: Jan. 4, 2018

(54) SIGNAL RECEIVING METHOD AND USER EQUIPMENT, AND SIGNAL RECEIVING METHOD AND BASE STATION

(71) Applicant: LG ELECTRONICS INC., Seoul (KR)

(72) Inventors: Hyangsun YOU, Seoul (KR); Yunjung YI, Seoul (KR)

(73) Assignee: LG ELECTRONICS INC., Seoul (KR)

(21) Appl. No.: 15/547,472

(22) PCT Filed: Jan. 29, 2016
(86) PCT No.: PCT/KR2016/001015

§ 371 Date: Jul. 28, 2017

Related U.S. Application Data
(60) Provisional application No. 62/109,073, filed on Jan. 29, 2015.
(60) Provisional application No. 62/146,211, filed on Apr. 10, 2015.
(60) Provisional application No. 62/162,646, filed on May 15, 2015.
(60) Provisional application No. 62/165,886, filed on May 22, 2015.

(51) Int. Cl. H04W 72/04; H04L 5/14; H04W 72/12

(52) U.S. Cl. CPC H04W 72/042; H04W 72/12; H04L 5/14; H04W 72/04

(57) ABSTRACT

The present invention provides an uplink signal transmission/receiving method and an apparatus therefor, and a downlink signal transmission/receiving method and an apparatus therefor. In a half duplex frequency division duplex (HD-FDD), when uplink transmission and downlink receipt are performed on the same subframe or neighboring subframes, a user equipment drops one of the uplink transmission and the downlink receipt according to a priority, and performs only transmission which is not dropped. The priority includes periodically unavailable resources, that is, aperiodic resources, taking priority over periodically available resources. If the uplink transmission is periodic, for example assigned in a semi-static manner or in a semi-persistent manner, and a downlink transmission is aperiodic, for example assigned dynamically, the user equipment drops the uplink transmission and performs the downlink receipt.

### TECHNICAL FIELD

The present invention relates to a wireless communication system, and more particularly, to a method and apparatus for transmitting/receiving an uplink signal and a method and apparatus for transmitting/receiving a downlink signal.

### BACKGROUND ART

With appearance and spread of machine-to-machine (M2M) communication and a variety of devices such as smartphones and tablet PCs and technology demanding a large amount of data transmission, data throughput needed in a cellular network has rapidly increased. To satisfy such rapidly increasing data throughput, carrier aggregation technology, cognitive radio technology, etc. for efficiently employing more frequency bands and multiple input multiple output (MIMO) technology, multi-base station (BS) cooperation technology, etc. for raising data capacity transmitted on limited frequency resources have been developed.

A general wireless communication system performs data transmission/reception through one downlink (DL) band and through one uplink (UL) band corresponding to the DL band (in case of a frequency division duplex (FDD) mode), or divides a prescribed radio frame into a UL time unit and a DL time unit in the time domain and then performs data transmission/reception through the UL/DL time unit (in case of a time division duplex (TDD) mode). A base station (BS) and a user equipment (UE) transmit and receive data and/or control information scheduled on a prescribed time unit basis, e.g. on a subframe basis. The data is transmitted and received through a data region configured in a UL/DL subframe and the control information is transmitted and received through a control region configured in the UL/DL subframe. To this end, various physical channels carrying radio signals are formed in the UL/DL subframe. In contrast, carrier aggregation technology serves to use a wider UL/DL bandwidth by aggregating a plurality of UL/DL frequency blocks in order to use a broader frequency band so that more signals relative to signals when a single carrier is used can be simultaneously processed.

In addition, a communication environment has evolved into increasing density of nodes accessible by a user at the periphery of the nodes. A node refers to a fixed point capable of transmitting/receiving a radio signal to/from the UE through one or more antennas. A communication system including high-density nodes may provide a better communication service to the UE through cooperation between the nodes.

### DETAILED DESCRIPTION OF THE INVENTION

### Technical Problems

Due to introduction of new radio communication technology, the number of user equipments (UEs) to which a BS should provide a service in a prescribed resource region increases and the amount of data and control information that the BS should transmit to the UEs increases. Since the amount of resources available to the BS for communication with the UE(s) is limited, a new method in which the BS efficiently receives/transmits uplink/downlink data and/or uplink/downlink control information using the limited radio resources is needed.

The technical objects that can be achieved through the present invention are not limited to what has been particularly described hereinabove and other technical objects not described herein will be more clearly understood by persons skilled in the art from the following detailed description.

### Technical Solutions

In half duplex frequency division duplex (HD-FDD), when UL and DL channels are scheduled in the same subframe or adjacent subframes, one of the UL and DL channels is dropped according to a priority order and then the other one, which is not dropped, can be transmitted. In this case, the priority order may be determined such that resources that are periodically unavailable, i.e., aperiodic resources take priority over periodically available resources. If the UL channel is periodic, for example, the UL channel is allocated in a semi-static or semi-persistent manner, and the DL channel is aperiodic, for example, the DL channel is allocated in a dynamic manner, the UL channel may be dropped and the DL channel may be transmitted/received.

In a first aspect of the present invention, provided herein is a method for receiving a signal, the method performed by a user equipment (UE) and including: receiving first scheduling information for configuring uplink resources; receiving second scheduling information for configuring downlink resources; and at least performing uplink transmission using the uplink resources according to the first scheduling information and performing downlink reception using the downlink resources according to the second scheduling information. In half duplex frequency division duplex (HD-FDD), if the uplink transmission and the downlink reception needs to be performed on a same subframe or adjacent subframes and if the uplink transmission is periodic and the downlink reception is aperiodic, the uplink transmission may be dropped and the downlink reception may be performed.

In a second aspect of the present invention, provided herein is a user equipment (UE) for receiving a signal, including: a radio frequency (RF) unit; and a processor configured to control the RF unit. In this case, the processor may be configured to: control the RF unit to receive first scheduling information for configuring uplink resources; control the RF unit to receive second scheduling information for configuring downlink resources; and control the RF unit to at least perform uplink transmission using the uplink resources according to the first scheduling information and perform downlink reception using the downlink resources according to the second scheduling information. In half duplex frequency division duplex (HD-FDD), if the uplink transmission and the downlink reception needs to be performed on a same subframe or adjacent subframes and if the uplink transmission is periodic and the downlink reception is aperiodic, the uplink transmission may be dropped and the downlink reception may be performed.

In a third aspect of the present invention, provided herein is a method for transmitting a signal to a user equipment (UE), the method performed by an evolved node B (eNB) and including: transmitting first scheduling information for configuring uplink resources; transmitting second scheduling information for configuring downlink resources; and at least receiving uplink transmission from the UE using the uplink resources according to the first scheduling information and performing downlink transmission to the UE using the downlink resources according to the second scheduling information. In half duplex frequency division duplex (HD-FDD), if the UE needs to perform the uplink transmission and receive the downlink transmission on a same subframe or adjacent subframes and if the uplink transmission is periodic and downlink reception is aperiodic, the reception of the uplink transmission may be dropped and the downlink transmission may be performed.

In a fourth aspect of the present invention, provided herein is an evolved node B (eNB) for transmitting a signal to a user equipment (UE), including: a radio frequency (RF) unit; and a processor configured to control the RF unit. In this case, the processor may be configured to: control the RF unit to transmit first scheduling information for configuring uplink resources; control the RF unit to transmit second scheduling information for configuring downlink resources; and control the RF unit to at least receive uplink transmission from the UE using the uplink resources according to the first scheduling information and perform downlink transmission to the UE using the downlink resources according to the second scheduling information. In half duplex frequency division duplex (HD-FDD), if the UE needs to perform the uplink transmission and receive the downlink transmission on a same subframe or adjacent subframes and if the uplink transmission is periodic and downlink reception is aperiodic, the processor may be configured to control the RF unit to drop the reception of the uplink transmission and perform the downlink transmission.

In all aspects of the present invention, the first scheduling information may be received through a physical downlink control channel (PDCCH). In addition, the downlink reception may be performed through a physical downlink shared channel (PDSCH) using the downlink resources.

In all aspects of the present invention, the second scheduling information may include information for configuring periodic channel state information (CSI) reporting

In all aspects of the present invention, when the uplink transmission and the downlink reception is scheduled on the same subframe, either the uplink transmission or the downlink reception may be performed in the following priority order: physical random access channel (PRACH), scheduling request (SR), acknowledgement/negative-acknowledgement (ACK/NACK), aperiodic channel state information (CSI), or aperiodic sounding reference signal (SRS)>physical uplink shared channel (PUSCH)>downlink data>enhanced physical downlink control channel (EPDCCH).

In all aspects of the present invention, the uplink transmission may be performed through the PUSCH.

The above technical solutions are merely some parts of the embodiments of the present invention and various embodiments into which the technical features of the present invention are incorporated can be derived and understood by persons skilled in the art from the following detailed description of the present invention.

### Advantageous Effect

According to the present invention, uplink/downlink signals can be efficiently transmitted/received. Therefore, overall throughput of a wireless communication system is improved.

According to an embodiment of the present invention, a low-price/low-cost UE can communicate with a BS while maintaining compatibility with a legacy system.

According to an embodiment of the present invention, a UE can be implemented with low price/low cost.

It will be appreciated by persons skilled in the art that that the effects that can be achieved through the present invention are not limited to what has been particularly described hereinabove and other advantages of the present invention will be more clearly understood from the following detailed description.

### DESCRIPTION OF DRAWINGS

The accompanying drawings, which are included to provide a further understanding of the invention, illustrate embodiments of the invention and together with the description serve to explain the principle of the invention.

FIG. 1 schematically illustrates three duplex schemes used in bidirectional radio communication.

FIG. 2 illustrates the structure of a radio frame used in a wireless communication system.

FIG. 3 illustrates the structure of a downlink (DL)/uplink (UL) slot in a wireless communication system.

FIG. 4 illustrates a radio frame structure for transmission of a synchronization signal (SS).

FIG. 5 illustrates the structure of a DL subframe used in a wireless communication system.

FIG. 6 illustrates a resource unit used to configure a DL control channel.

FIG. 7 illustrates configuration of cell specific reference signals (CRSs) and user specific reference signals (UE-RS).

FIG. 8 illustrates channel state information reference signal (CSI-RS) configurations.

FIG. 9 illustrates the structure of a UL subframe used in a wireless communication system.

FIG. 10 illustrates an uplink-downlink frame timing relationship.

FIG. 11 is an example of a downlink control channel configured in a data region of a DL subframe.

FIG. 12 illustrates an exemplary signal band for MTC.

FIG. 13 illustrates processing for overlapping PDSCHs according to embodiments of the present invention.

FIG. 14 illustrates channel collisions that can occur in a same narrowband or different narrowbands.

FIG. 15 illustrates methods of solving a collision between channels according to embodiments of the present invention.

FIG. 16 illustrates a collision between two subframes for two channels.

FIG. 17 is a block diagram illustrating elements of a transmitting device 10 and a receiving device 20 for implementing the present invention.

### MODE FOR CARRYING OUT THE INVENTION

Reference will now be made in detail to the exemplary embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the invention. The following detailed description includes specific details in order to provide a thorough understanding of the present invention. However, it will be apparent to those skilled in the art that the present invention may be practiced without such specific details.

In some instances, known structures and devices are omitted or are shown in block diagram form, focusing on important features of the structures and devices, so as not to obscure the concept of the present invention. The same reference numbers will be used throughout this specification to refer to the same or like parts.

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE. For convenience of description, it is assumed that the present invention is applied to 3GPP LTE/LTE-A. However, the technical features of the present invention are not limited thereto. For example, although the following detailed description is given based on a mobile communication system corresponding to a 3GPP LTE/LTE-A system, aspects of the present invention that are not specific to 3GPP LTE/LTE-A are applicable to other mobile communication systems.

For example, the present invention is applicable to contention based communication such as Wi-Fi as well as non-contention based communication as in the 3GPP LTE/LTE-A system in which an eNB allocates a DL/UL time/frequency resource to a UE and the UE receives a DL signal and transmits a UL signal according to resource allocation of the eNB. In a non-contention based communication scheme, an access point (AP) or a control node for controlling the AP allocates a resource for communication between the UE and the AP, whereas, in a contention based communication scheme, a communication resource is occupied through contention between UEs which desire to access the AP. The contention based communication scheme will now be described in brief. One type of the contention based communication scheme is carrier sense multiple access (CSMA). CSMA refers to a probabilistic media access control (MAC) protocol for confirming, before a node or a communication device transmits traffic on a shared transmission medium (also called a shared channel) such as a frequency band, that there is no other traffic on the same shared transmission medium. In CSMA, a transmitting device determines whether another transmission is being performed before attempting to transmit traffic to a receiving device. In other words, the transmitting device attempts to detect presence of a carrier from another transmitting device before attempting to perform transmission. Upon sensing the carrier, the transmitting device waits for another transmission device which is performing transmission to finish transmission, before performing transmission thereof. Consequently, CSMA can be a communication scheme based on the principle of “sense before transmit” or “listen before talk”. A scheme for avoiding collision between transmitting devices in the contention based communication system using CSMA includes carrier sense multiple access with collision detection (CSMA/CD) and/or carrier sense multiple access with collision avoidance (CSMA/CA). CSMA/CD is a collision detection scheme in a wired local area network (LAN) environment. In CSMA/CD, a personal computer (PC) or a server which desires to perform communication in an Ethernet environment first confirms whether communication occurs on a network and, if another device carries data on the network, the PC or the server waits and then transmits data. That is, when two or more users (e.g. PCs, UEs, etc.) simultaneously transmit data, collision occurs between simultaneous transmission and CSMA/CD is a scheme for flexibly transmitting data by monitoring collision. A transmitting device using CSMA/CD adjusts data transmission thereof by sensing data transmission performed by another device using a specific rule. CSMA/CA is a MAC protocol specified in IEEE 802.11 standards. A wireless LAN (WLAN) system conforming to IEEE 802.11 standards does not use CSMA/CD which has been used in IEEE 802.3 standards and uses CA, i.e. a collision avoidance scheme. Transmission devices always sense carrier of a network and, if the network is empty, the transmission devices wait for determined time according to locations thereof registered in a list and then transmit data. Various methods are used to determine priority of the transmission devices in the list and to reconfigure priority. In a system according to some versions of IEEE 802.11 standards, collision may occur and, in this case, a collision sensing procedure is performed. A transmission device using CSMA/CA avoids collision between data transmission thereof and data transmission of another transmission device using a specific rule.

In the present invention, a user equipment (UE) may be a fixed or mobile device. Examples of the UE include various devices that transmit and receive user data and/or various kinds of control information to and from a base station (BS). The UE may be referred to as a terminal equipment (TE), a mobile station (MS), a mobile terminal (MT), a user terminal (UT), a subscriber station (SS), a wireless device, a personal digital assistant (PDA), a wireless modem, a handheld device, etc. In addition, in the present invention, a BS generally refers to a fixed station that performs communication with a UE and/or another BS, and exchanges various kinds of data and control information with the UE and another BS. The BS may be referred to as an advanced base station (ABS), a node-B (NB), an evolved node-B (eNB), a base transceiver system (BTS), an access point (AP), a processing server (PS), etc. In describing the present invention, a BS will be referred to as an eNB.

In the present invention, a node refers to a fixed point capable of transmitting/receiving a radio signal through communication with a UE. Various types of eNBs may be used as nodes irrespective of the terms thereof. For example, a BS, a node B (NB), an e-node B (eNB), a pico-cell eNB (PeNB), a home eNB (HeNB), a relay, a repeater, etc. may be a node. In addition, the node may not be an eNB. For example, the node may be a radio remote head (RRH) or a radio remote unit (RRU). The RRH or RRU generally has a lower power level than a power level of an eNB. Since the RRH or RRU (hereinafter, RRH/RRU) is generally connected to the eNB through a dedicated line such as an optical cable, cooperative communication between RRH/RRU and the eNB can be smoothly performed in comparison with cooperative communication between eNBs connected by a radio line. At least one antenna is installed per node. The antenna may mean a physical antenna or mean an antenna port, a virtual antenna, or an antenna group. A node may be referred to as a point.

In the present invention, a cell refers to a prescribed geographic region to which one or more nodes provide a communication service. Accordingly, in the present invention, communicating with a specific cell may mean communicating with an eNB or a node which provides a communication service to the specific cell. In addition, a DL/UL signal of a specific cell refers to a DL/UL signal from/to an eNB or a node which provides a communication service to the specific cell. A node providing UL/DL communication services to a UE is called a serving node and a cell to which UL/DL communication services are provided by the serving node is especially called a serving cell. Furthermore, channel status/quality of a specific cell refers to channel status/quality of a channel or communication link formed between an eNB or node which provides a communication service to the specific cell and a UE. In a LTE/LTE-A based system, The UE may measure DL channel state received from a specific node using cell-specific reference signal(s) (CRS(s)) transmitted on a CRS resource allocated by antenna port(s) of the specific node to the specific node and/or channel state information reference signal(s) (CSI-RS(s)) transmitted on a CSI-RS resource. For a detailed CSI-RS configuration, refer to documents such as 3GPP TS 36.211 and 3GPP TS 36.331.

Meanwhile, a 3GPP LTE/LTE-A system uses the concept of a cell to manage a radio resource. A cell associated with the radio resource is different from a cell of a geographic region.

A “cell” of a geographic region may be understood as coverage within which a node can provide a service using a carrier and a “cell” of a radio resource is associated with bandwidth (BW) which is a frequency range configured by the carrier. Since DL coverage, which is a range within which the node is capable of transmitting a valid signal, and UL coverage, which is a range within which the node is capable of receiving the valid signal from the UE, depends upon a carrier carrying the signal, coverage of the node may be associated with coverage of “cell” of a radio resource used by the node. Accordingly, the term “cell” may be used to indicate service coverage by the node sometimes, a radio resource at other times, or a range that a signal using a radio resource can reach with valid strength at other times. The “cell” of the radio resource will be described later in more detail.

3GPP LTE/LTE-A standards define DL physical channels corresponding to resource elements carrying information derived from a higher layer and DL physical signals corresponding to resource elements which are used by a physical layer but which do not carry information derived from a higher layer. For example, a physical downlink shared channel (PDSCH), a physical broadcast channel (PBCH), a physical multicast channel (PMCH), a physical control format indicator channel (PCFICH), a physical downlink control channel (PDCCH), and a physical hybrid ARQ indicator channel (PHICH) are defined as the DL physical channels, and a reference signal and a synchronization signal are defined as the DL physical signals. A reference signal (RS), also called a pilot, refers to a special waveform of a predefined signal known to both a BS and a UE. For example, a cell-specific RS (CRS), a UE-specific RS (UE-RS), a positioning RS (PRS), and channel state information RS (CSI-RS) may be defined as DL RSs. Meanwhile, the 3GPP LTE/LTE-A standards define UL physical channels corresponding to resource elements carrying information derived from a higher layer and UL physical signals corresponding to resource elements which are used by a physical layer but which do not carry information derived from a higher layer. For example, a physical uplink shared channel (PUSCH), a physical uplink control channel (PUCCH), and a physical random access channel (PRACH) are defined as the UL physical channels, and a demodulation reference signal (DMRS) for a UL control/data signal and a sounding reference signal (SRS) used for UL channel measurement are defined as the UL physical signal.

In the present invention, a physical downlink control channel (PDCCH), a physical control format indicator channel (PCFICH), a physical hybrid automatic retransmit request indicator channel (PHICH), and a physical downlink shared channel (PDSCH) refer to a set of time-frequency resources or resource elements (REs) carrying downlink control information (DCI), a set of time-frequency resources or REs carrying a control format indicator (CFI), a set of time-frequency resources or REs carrying downlink acknowledgement (ACK)/negative ACK (NACK), and a set of time-frequency resources or REs carrying downlink data, respectively. In addition, a physical uplink control channel (PUCCH), a physical uplink shared channel (PUSCH) and a physical random access channel (PRACH) refer to a set of time-frequency resources or REs carrying uplink control information (UCI), a set of time-frequency resources or REs carrying uplink data and a set of time-frequency resources or REs carrying random access signals, respectively. In the present invention, in particular, a time-frequency resource or RE that is assigned to or belongs to PDCCH/PCFICH/PHICH/PDSCH/PUCCH/PUSCH/PRACH is referred to as PDCCH/PCFICH/PHICH/PDSCH/PUCCH/PUSCH/PRACH RE or PDCCH/PCFICH/PHICH/PDSCH/PUCCH/PUSCH/PRACH time-frequency resource, respectively. Therefore, in the present invention, PUCCH/PUSCH/PRACH transmission of a UE is conceptually identical to UCI/uplink data/random access signal transmission on PUSCH/PUCCH/PRACH, respectively. In addition, PDCCH/PCFICH/PHICH/PDSCH transmission of an eNB is conceptually identical to downlink data/DCI transmission on PDCCH/PCFICH/PHICH/PDSCH, respectively.

Hereinafter, OFDM symbol/subcarrier/RE to or for which CRS/DMRS/CSI-RS/SRS/UE-RS is assigned or configured will be referred to as CRS/DMRS/CSI-RS/SRS/UE-RS symbol/carrier/subcarrier/RE. For example, an OFDM symbol to or for which a tracking RS (TRS) is assigned or configured is referred to as a TRS symbol, a subcarrier to or for which the TRS is assigned or configured is referred to as a TRS subcarrier, and an RE to or for which the TRS is assigned or configured is referred to as a TRS RE. In addition, a subframe configured for transmission of the TRS is referred to as a TRS subframe. Moreover, a subframe in which a broadcast signal is transmitted is referred to as a broadcast subframe or a PBCH subframe and a subframe in which a synchronization signal (e.g. PSS and/or SSS) is transmitted is referred to a synchronization signal subframe or a PSS/SSS subframe. OFDM symbol/subcarrier/RE to or for which PSS/SSS is assigned or configured is referred to as PSS/SSS symbol/subcarrier/RE, respectively.

In the present invention, a CRS port, a UE-RS port, a CSI-RS port, and a TRS port refer to an antenna port configured to transmit a CRS, an antenna port configured to transmit a UE-RS, an antenna port configured to transmit a CSI-RS, and an antenna port configured to transmit a TRS, respectively. Antenna ports configured to transmit CRSs may be distinguished from each other by the locations of REs occupied by the CRSs according to CRS ports, antenna ports configured to transmit UE-RSs may be distinguished from each other by the locations of REs occupied by the UE-RSs according to UE-RS ports, and antenna ports configured to transmit CSI-RSs may be distinguished from each other by the locations of REs occupied by the CSI-RSs according to CSI-RS ports. Therefore, the term CRS/UE-RS/CSI-RS/TRS ports may also be used to indicate a pattern of REs occupied by CRSs/UE-RSs/CSI-RSs/TRSs in a predetermined resource region.

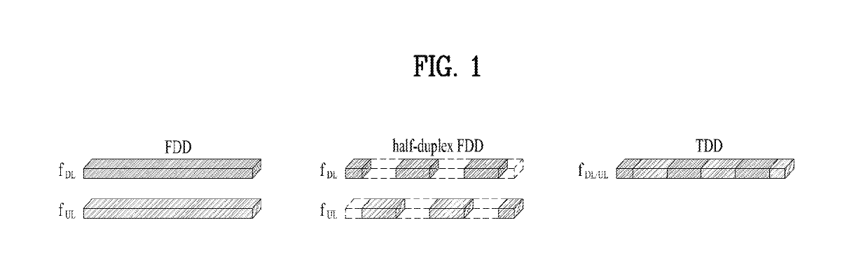

FIG. 1 schematically illustrates three duplex schemes used in bidirectional radio communication.

Uplink (UL)/downlink (DL) configuration in a frame varies with a duplexing scheme. Duplex refers to bidirectional communication between two devices, distinguished from simplex indicating unidirectional communication. In bidirectional communication, transmission on bidirectional links may occur at the same time (full-duplex) or at separate times (half-duplex).

Referring to FIG. 1(a), a full-duplex transceiver is used to separate two communication links of opposite directions in the frequency domain. That is, different carrier frequencies are adopted in respective link directions. Duplex using different carrier frequencies in respective link directions is referred to as frequency division duplex (FDD). Conversely, a half-duplex transceiver is used to separate two communication links of opposite directions in the time domain. Referring to FIG. 1(c), duplex using the same carrier frequency in respective link directions is referred to as time division duplex (TDD). Referring to FIG. 1(b), the half-duplex transceiver may use different carrier frequencies in respective link directions and this is referred to as half duplex FDD (HD-FDD). In HD-FDD, communication of opposite directions for a specific device occurs not only on different carrier frequencies but also at different timings. Therefore, HD-FDD is regarded as a hybrid of FDD and TDD.

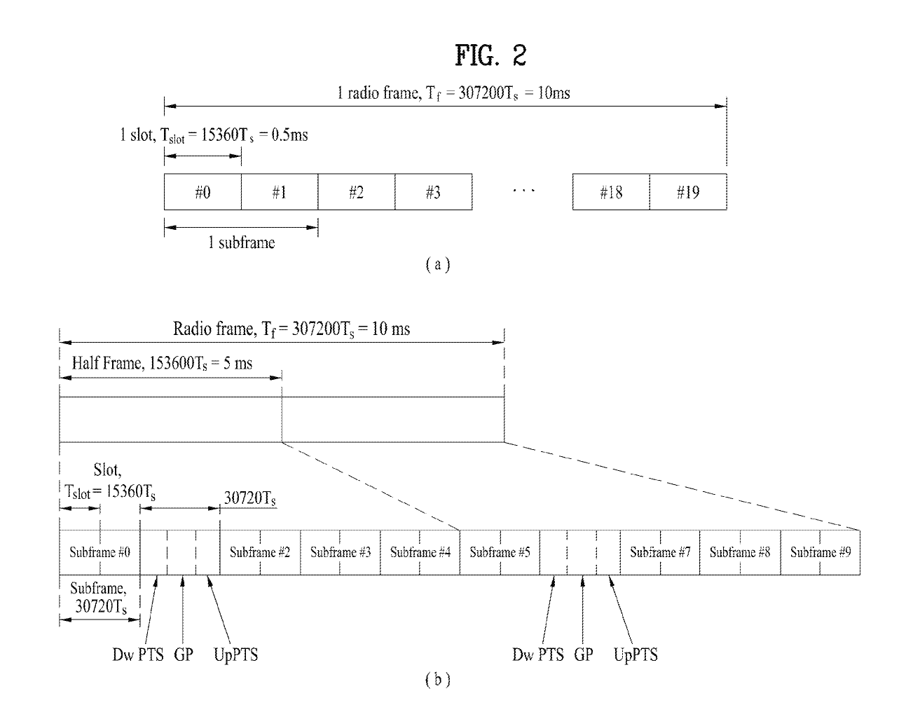

FIG. 2 illustrates the structure of a radio frame used in a wireless communication system.

Specifically, FIG. 2(a) illustrates an exemplary structure of a radio frame which can be used in frequency division multiplexing (FDD) in 3GPP LTE/LTE-A and FIG. 2(b) illustrates an exemplary structure of a radio frame which can be used in time division multiplexing (TDD) in 3GPP LTE/LTE-A. The frame structure of FIG. 2(a) is referred to as frame structure type 1 (FS1) and the frame structure of FIG. 2(b) is referred to as frame structure type 2 (FS2).

Referring to FIG. 2, a 3GPP LTE/LTE-A radio frame is 10 ms (307,200 Tₛ) in duration. The radio frame is divided into 10 subframes of equal size. Subframe numbers may be assigned to the 10 subframes within one radio frame, respectively. Here, Tₛ denotes sampling time where Tₛ=1/(2048*15 kHz). Each subframe is 1 ms long and is further divided into two slots. 20 slots are sequentially numbered from 0 to 19 in one radio frame. Duration of each slot is 0.5 ms. A time interval in which one subframe is transmitted is defined as a transmission time interval (TTI). Time resources may be distinguished by a radio frame number (or radio frame index), a subframe number (or subframe index), a slot number (or slot index), and the like.

A radio frame may have different configurations according to duplex modes. In FDD mode for example, since DL transmission and UL transmission are discriminated according to frequency, a radio frame for a specific frequency band operating on a carrier frequency includes either DL subframes or UL subframes. In TDD mode, since DL transmission and UL transmission are discriminated according to time, a radio frame for a specific frequency band operating on a carrier frequency includes both DL subframes and UL subframes.

Table 1 shows an exemplary UL-DL configuration within a radio frame in TDD mode.

TABLE 1

| | Downlink- | | | | | | | | | | |
|---|---|---|---|---|---|---|---|---|---|---|---|
| Uplink- | to-Uplink | | | | | | | | | | |
| downlink | Switch- | | | | | | | | | | |
| config- | point | Subframe number | | | | | | | | | |
| uration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 1, D denotes a DL subframe, U denotes a UL subframe, and S denotes a special subframe. The special subframe includes three fields, i.e. downlink pilot time slot (DwPTS), guard period (GP), and uplink pilot time slot (UpPTS). DwPTS is a time slot reserved for DL transmission and UpPTS is a time slot reserved for UL transmission. Table 2 shows an example of the special subframe configuration.

TABLE 2

| | Normal cyclic prefix in downlink | | | Extended cyclic prefix in down | | |
|---|---|---|---|---|---|---|
| | | UpPTS | | | UpPTS | |
| Special | | Normal | Extended | | Normal | Extended |
| subframe | | cyclic prefix | cyclic prefix | | cyclic prefix | cyclic prefix |
| configuration | DwPTS | in uplink | in uplink | DwPTS | in uplink | in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | — |
| 6 | 19760 · Tₛ | | | 23040 · Tₛ | | |
| 7 | 21952 · Tₛ | | | 12800 · Tₛ | | |
| 8 | 24144 · Tₛ | | | — | — | — |
| 9 | 13168 · Tₛ | | | — | — | — |

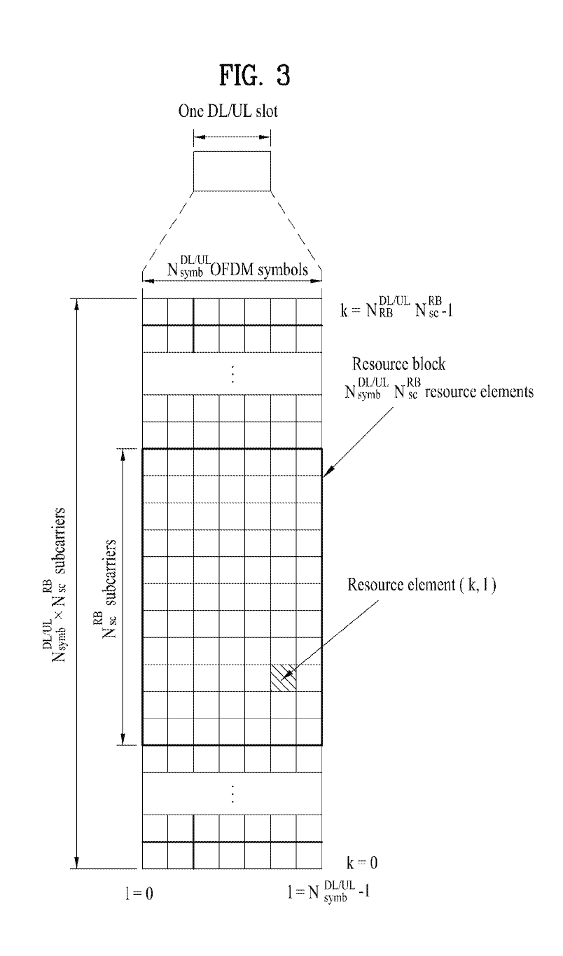

FIG. 3 illustrates the structure of a DL/UL slot structure in a wireless communication system. In particular, FIG. 3 illustrates the structure of a resource grid of a 3GPP LTE/LTE-A system. One resource grid is defined per antenna port.

Referring to FIG. 3, a slot includes a plurality of orthogonal frequency division multiplexing (OFDM) symbols in the time domain and includes a plurality of resource blocks (RBs) in the frequency domain. The OFDM symbol may refer to one symbol duration. Referring to FIG. 3, a signal transmitted in each slot may be expressed by a resource grid including B^{DL/UL}_{RB}*N^{RB}_{sc} subcarriers and N^{DL/UL}_{symb} OFDM symbols. N^{DL}_{RB} denotes the number of RBs in a DL slot and N^{UL}_{RB} denotes the number of RBs in a UL slot. N^{DL}_{RB} and N^{UL}_{RB} depend on a DL transmission bandwidth and a UL transmission bandwidth, respectively. N^{DL}_{symb} denotes the number of OFDM symbols in a DL slot, N^{UL}_{symb} denotes the number of OFDM symbols in a UL slot, and N^{RB}_{sc} denotes the number of subcarriers configuring one RB.

An OFDM symbol may be referred to as an OFDM symbol, a single carrier frequency division multiplexing (SC-FDM) symbol, etc. according to multiple access schemes. The number of OFDM symbols included in one slot may be varied according to channel bandwidths and CP lengths. For example, in a normal cyclic prefix (CP) case, one slot includes 7 OFDM symbols. In an extended CP case, one slot includes 6 OFDM symbols. Although one slot of a subframe including 7 OFDM symbols is shown in FIG. 3 for convenience of description, embodiments of the present invention are similarly applicable to subframes having a different number of OFDM symbols. Referring to FIG. 3, each OFDM symbol includes N^{DL/UL}_{RB}*N^{RB}_{sc} subcarriers in the frequency domain. The type of the subcarrier may be divided into a data subcarrier for data transmission, a reference signal (RS) subcarrier for RS transmission, and a null subcarrier for a guard band and a DC component. The null subcarrier for the DC component is unused and is mapped to a carrier frequency f₀ in a process of generating an OFDM signal or in a frequency up-conversion process. The carrier frequency is also called a center frequency f_{c}.

One RB is defined as N^{DL/UL}_{symb} (e.g. 7) consecutive OFDM symbols in the time domain and as N^{RB}_{sc} (e.g. 12) consecutive subcarriers in the frequency domain. For reference, a resource composed of one OFDM symbol and one subcarrier is referred to a resource element (RE) or tone. Accordingly, one RB includes N^{DL/UL}_{symb}*N^{RB}_{sc} REs. Each RE within a resource grid may be uniquely defined by an index pair (k, l) within one slot. k is an index ranging from 0 to N^{DL/UL}_{RB}*N^{RB}_{sc}−1 in the frequency domain, and l is an index ranging from 0 to N^{DL/UL}_{symb}1−1 in the time domain.

Meanwhile, one RB is mapped to one physical resource block (PRB) and one virtual resource block (VRB). A PRB is defined as N^{DL}_{symb} (e.g. 7) consecutive OFDM or SC-FDM symbols in the time domain and N^{RB}_{sc} (e.g. 12) consecutive subcarriers in the frequency domain. Accordingly, one PRB is configured with N^{DL/UL}_{symb}*N^{RB}_{sc} REs. In one subframe, two RBs each located in two slots of the subframe while occupying the same N^{RB}_{sc} consecutive subcarriers are referred to as a physical resource block (PRB) pair. Two RBs configuring a PRB pair have the same PRB number (or the same PRB index).

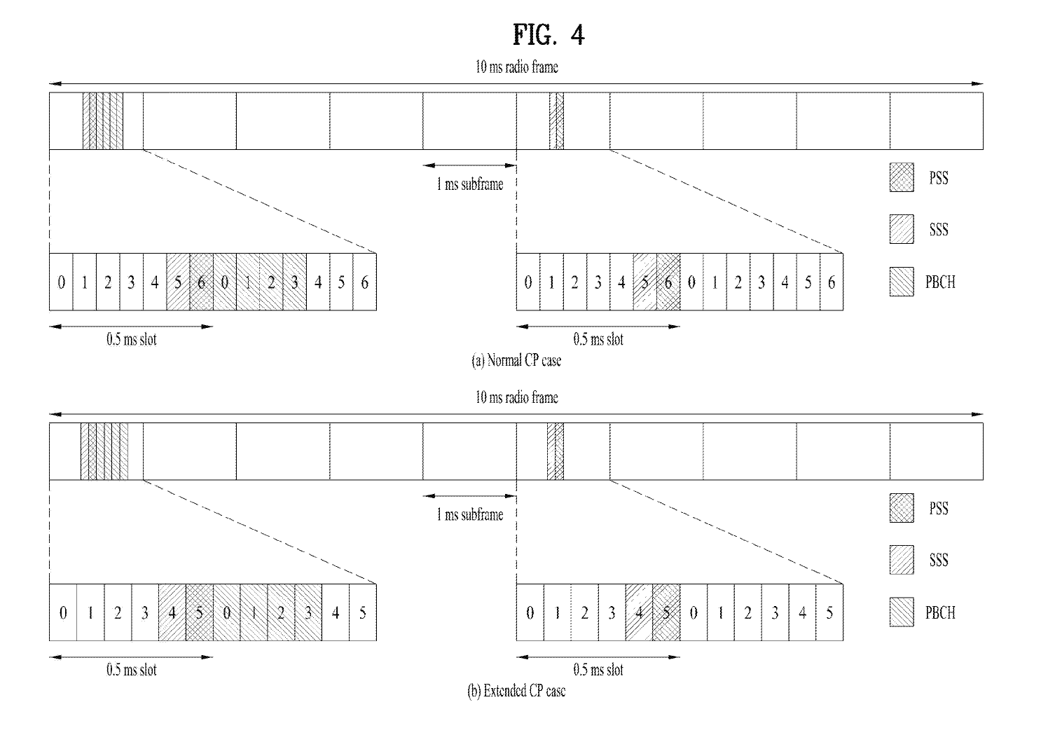

FIG. 4 illustrates a radio frame structure for transmission of a synchronization signal (SS). Specifically, FIG. 4 illustrates a radio frame structure for transmission of an SS and a PBCH in frequency division duplex (FDD), wherein FIG. 4(a) illustrates transmission locations of an SS and a PBCH in a radio frame configured as a normal cyclic prefix (CP) and FIG. 4(b) illustrates transmission locations of an SS and a PBCH in a radio frame configured as an extended CP.

If a UE is powered on or newly enters a cell, the UE performs an initial cell search procedure of acquiring time and frequency synchronization with the cell and detecting a physical cell identity N^{cell}_{ID} of the cell. To this end, the UE may establish synchronization with the eNB by receiving synchronization signals, e.g. a primary synchronization signal (PSS) and a secondary synchronization signal (SSS), from the eNB and obtain information such as a cell identity (ID).

An SS will be described in more detail with reference to FIG. 4. An SS is categorized into a PSS and an SSS. The PSS is used to acquire time-domain synchronization of OFDM symbol synchronization, slot synchronization, etc. and/or frequency-domain synchronization and the SSS is used to acquire frame synchronization, a cell group ID, and/or CP configuration of a cell (i.e. information as to whether a normal CP is used or an extended CP is used). Referring to FIG. 4, each of a PSS and an SSS is transmitted on two OFDM symbols of every radio frame. More specifically, SSs are transmitted in the first slot of subframe 0 and the first slot of subframe 5, in consideration of a global system for mobile communication (GSM) frame length of 4.6 ms for facilitation of inter-radio access technology (inter-RAT) measurement. Especially, a PSS is transmitted on the last OFDM symbol of the first slot of subframe 0 and on the last OFDM symbol of the first slot of subframe 5 and an SSS is transmitted on the second to last OFDM symbol of the first slot of subframe 0 and on the second to last OFDM symbol of the first slot of subframe 5. A boundary of a corresponding radio frame may be detected through the SSS. The PSS is transmitted on the last OFDM symbol of a corresponding slot and the SSS is transmitted on an OFDM symbol immediately before an OFDM symbol on which the PSS is transmitted. A transmit diversity scheme of an SS uses only a single antenna port and standards therefor are not separately defined.

Upon detecting a PSS, a UE may discern that a corresponding subframe is one of subframe 0 and subframe 5 because the PSS is transmitted every 5 ms but the UE cannot discern whether the subframe is subframe 0 or subframe 5. Accordingly, the UE cannot recognize the boundary of a radio frame only by the PSS. That is, frame synchronization cannot be acquired only by the PSS. The UE detects the boundary of a radio frame by detecting SSSs which is transmitted twice in one radio frame with different sequences.

A UE, which has demodulated a DL signal by performing a cell search procedure using an SSS and determined time and frequency parameters necessary for transmitting a UL signal at an accurate time, can communicate with an eNB only after acquiring system information necessary for system configuration of the UE from the eNB.

The system information is configured by a master information block (MIB) and system information blocks (SIBs). Each SIB includes a set of functionally associated parameters and is categorized into an MIB, SIB Type 1 (SIB1), SIB Type 2 (SIB2), and SIB3 to SIB17 according to included parameters.

The MIB includes most frequency transmitted parameters which are essential for initial access of the UE to a network of the eNB. The UE may receive the MIB through a broadcast channel (e.g. a PBCH). The MIB includes DL bandwidth (BW), PHICH configuration, and a system frame number SFN. Accordingly, the UE can be explicitly aware of information about the DL BW, SFN, and PHICH configuration by receiving the PBCH. Meanwhile, information which can be implicitly recognized by the UE through reception of the PBCH is the number of transmit antenna ports of the eNB. Information about the number of transmit antennas of the eNB is implicitly signaled by masking (e.g. XOR operation) a sequence corresponding to the number of transmit antennas to a 16-bit cyclic redundancy check (CRC) used for error detection of the PBCH.

SIB1 includes not only information about time-domain scheduling of other SIBs but also parameters needed to determine whether a specific cell is suitable for cell selection. SIB1 is received by the UE through broadcast signaling or dedicated signaling.

A DL carrier frequency and a system BW corresponding to the DL carrier frequency may be acquired by the MIB that the PBCH carries. A UL carrier frequency and a system BW corresponding to the UL carrier frequency may be acquired through system information which is a DL signal. If no stored valid system information about a corresponding cell is present as a result of receiving the MIB, the UE applies a DL BW in the MIB to a UL BW until SIB2 is received. For example, the UE may recognize an entire UL system BW which is usable for UL transmission thereby through UL-carrier frequency and UL-BW information in SIB2 by acquiring SIB2.

In the frequency domain, a PSS/SSS and a PBCH are transmitted only in a total of 6 RBs, i.e. a total of 72 subcarriers, irrespective of actual system BW, wherein 3 RBs are in the left and the other 3 RBs are in the right centering on a DC subcarrier on corresponding OFDM symbols. Therefore, the UE is configured to detect or decode the SS and the PBCH irrespective of DL BW configured for the UE.

After initial cell search, the UE may perform a random access procedure to complete access to the eNB. To this end, the UE may transmit a preamble through a physical random access channel (PRACH) and receive a response message to the preamble through a PDCCH and a PDSCH. In contention based random access, the UE may perform additional PRACH transmission and a contention resolution procedure of a PDCCH and a PDSCH corresponding to the PDCCH.

After performing the aforementioned procedure, the UE may perform PDDCH/PDSCH reception and PUSCH/PUCCH transmission as general uplink/downlink transmission procedures.

The random access procedure is also referred to as a random access channel (RACH) procedure. The random access procedure is used for various purposes including initial access, adjustment of uplink synchronization, resource assignment, and handover. Random access procedures are classified into a contention-based procedure and a dedicated (i.e., non-contention-based) procedure. The contention-based random access procedure is used for general operations including initial access, while the dedicated random access procedure is used for limited operations such as handover. In the contention-based random access procedure, the UE randomly selects a RACH preamble sequence. Accordingly, it is possible that multiple UEs transmit the same RACH preamble sequence at the same time. Thereby, a contention resolution procedure needs to be subsequently performed. On the other hand, in the dedicated random access procedure, the UE uses an RACH preamble sequence that the eNB uniquely allocates to the UE. Accordingly, the random access procedure may be performed without contention with other UEs.

The contention-based random access procedure includes the following four steps. Messages transmitted in Steps 1 to 4 given below may be referred to as Msg1 to Msg4.
Step 1: RACH preamble (via PRACH) (from UE to eNB)
Step 2: Random access response (RAR) (via PDCCH and PDSCH) (from eNB to UE)
Step 3: Layer 2/layer 3 message (via PUSCH) (from UE to eNB)
Step 4: Contention resolution message (from eNB to UE)

The dedicated random access procedure includes the following three steps. Messages transmitted in Steps 0 to 2 may be referred to as Msg0 to Msg2, respectively. Uplink transmission (i.e., Step 3) corresponding to the RAR may also be performed as a part of the random access procedure. The dedicated random access procedure may be triggered using a PDCCH for ordering transmission of an RACH preamble (hereinafter, a PDCCH order).
Step 0: RACH preamble assignment (from eNB to UE) through dedicated signaling
Step 1: RACH preamble (via PRACH) (from UE to eNB)
Step 2: RAR (via PDCCH and PDSCH) (from eNB to UE)

After transmitting the RACH preamble, the UE attempts to receive a random access response (RAR) within a preset time window. Specifically, the UE attempts to detect a PDCCH with RA-RNTI (Random Access RNTI) (hereinafter, RA-RNTI PDCCH) (e.g., CRC is masked with RA-RNTI on the PDCCH) in the time window. In detecting the RA-RNTI PDCCH, the UE checks the PDSCH for presence of an RAR directed thereto. The RAR includes timing advance (TA) information indicating timing offset information for UL synchronization, UL resource allocation information (UL grant information), and a random UE identifier (e.g., temporary cell-RNTI (TC-RNTI)). The UE may perform UL transmission (of, e.g., Msg3) according to the resource allocation information and the TA value in the RAR. HARQ is applied to UL transmission corresponding to the RAR. Accordingly, after transmitting Msg3, the UE may receive acknowledgement information (e.g., PHICH) corresponding to Msg3.

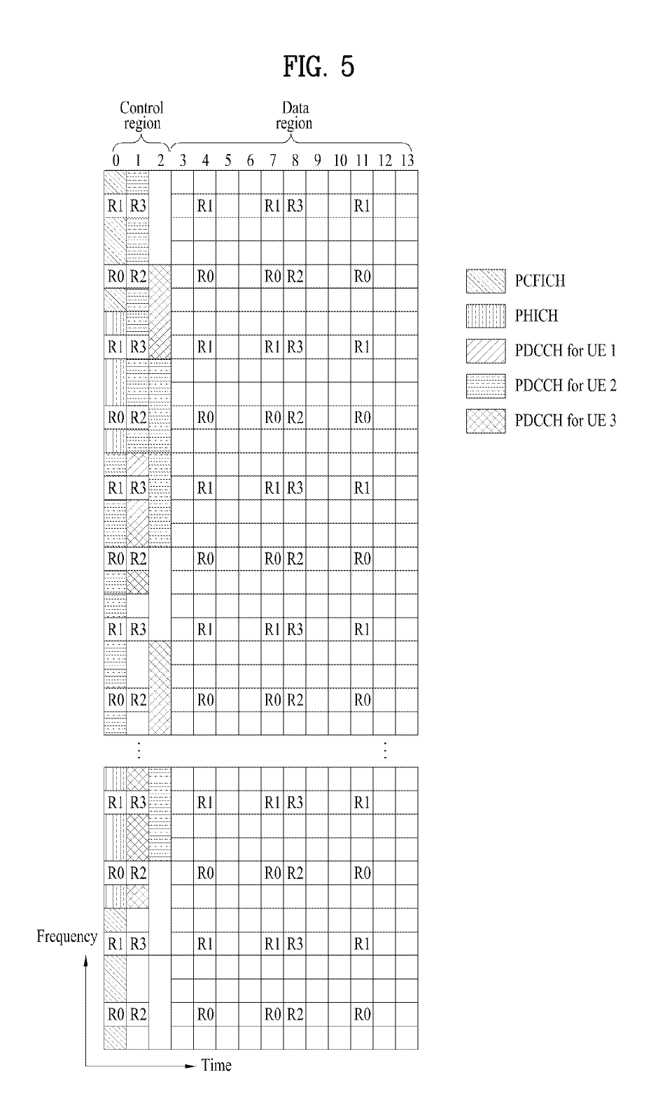

FIG. 5 illustrates the structure of a DL subframe used in a wireless communication system.

Referring to FIG. 5, a DL subframe is divided into a control region and a data region in the time domain. Referring to FIG. 5, a maximum of 3 (or 4) OFDM symbols located in a front part of a first slot of a subframe corresponds to the control region. Hereinafter, a resource region for PDCCH transmission in a DL subframe is referred to as a PDCCH region. OFDM symbols other than the OFDM symbol(s) used in the control region correspond to the data region to which a physical downlink shared channel (PDSCH) is allocated. Hereinafter, a resource region available for PDSCH transmission in the DL subframe is referred to as a PDSCH region.

Examples of a DL control channel used in 3GPP LTE include a physical control format indicator channel (PCFICH), a physical downlink control channel (PDCCH), a physical hybrid ARQ indicator channel (PHICH), etc.

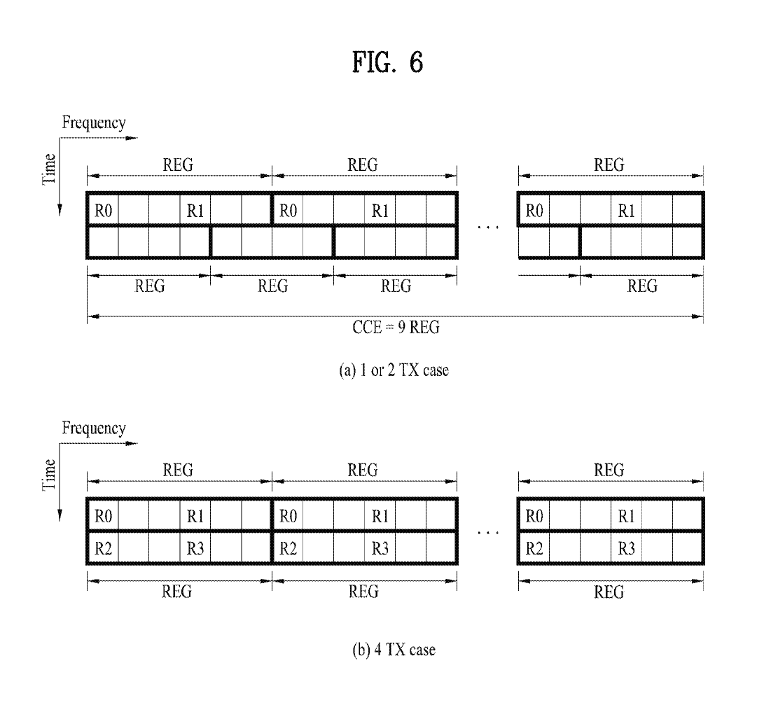

The PCFICH is transmitted in the first OFDM symbol of a subframe and carries information about the number of OFDM symbols available for transmission of a control channel within a subframe. The PCFICH notifies the UE of the number of OFDM symbols used for the corresponding subframe every subframe. The PCFICH is located at the first OFDM symbol. The PCFICH is configured by four resource element groups (REGs), each of which is distributed within a control region on the basis of cell ID. One REG includes four REs. One REG includes 4 REs. The structure of the REG will be described in more detail with reference to FIG. 6.

A set of OFDM symbols available for the PDCCH at a subframe is given by the following table.

TABLE 3

| | Number of OFDM | Number of OFDM |
|---|---|---|
| | symbols for | symbols for |
| | PDCCH when | PDCCH when |
| Subframe | N^{NL}_{RB}>10 | N^{DL}_{RB}≦10 |
| Subframe 1 and 6 for frame structure type 2 | 1, 2 | 2 |
| MBSFN subframes on a carrier supporting PDSCH, | 1, 2 | 2 |
| configured with 1 or 2 cell-specific antenna ports | | |
| MBSFN subframes on a carrier supporting PDSCH, | 2 | 2 |
| configured with 4 cell-specific antenna ports | | |
| Subframes on a carrier not supporting PDSCH | 0 | 0 |
| Non-MBSFN subframes (except subframe 6 for | 1, 2, 3 | 2, 3 |
| frame structure type 2) configured with positioning | | |
| reference signals | | |
| All other cases | 1, 2, 3 | 2, 3, 4 |

A subset of DL subframes in a radio frame on a carrier supporting PDSCH transmission may be configured as MBSFN subframe(s) by a higher layer. Each MBSFN subframe is divided into a non-MBSFN region and an MBSFN region. The non-MBSFN region spans one or two front OFDM symbols, wherein the length of the non-MBSFN region is given by Table 3. For transmission in the non-MBSFN region of the MBSFN subframe, the same cyclic prefix (CP) as a CP used for subframe 0 is used. The MBSFN region in the MBSFN subframe is defined as OFDM symbols which are not used for the non-MBSFN region.

The PCFICH carries a control format indicator (CFI), which indicates any one of values of 1 to 3. For a downlink system bandwidth N^{DL}_{RB}>10, the number 1, 2 or 3 of OFDM symbols which are spans of DCI carried by the PDCCH is given by the CFI. For a downlink system bandwidth N^{DL}_{RB}≦10, the number 2, 3 or 4 of OFDM symbols which are spans of DCI carried by the PDCCH is given by CFI+1. The CFI is coded in accordance with the following Table.

TABLE 4

| | CFI code word |
|---|---|
| CFI | <b₀, b₁, . . . , b₃₁> |
| 1 | <0, 1, 1, 0, 1, 1, 0, 1, 1, 0, 1, 1, 0, 1, 1, 0, 1, 1, 0, 1, 1, 0, 1, 1, 0, 1, 1, 0, 1, 1, 0, 1> |
| 2 | <1, 0, 1, 1, 0, 1, 1, 0, 1, 1, 0, 1, 1, 0, 1, 1, 0, 1, 1, 0, 1, 1, 0, 1, 1, 0, 1, 1, 0, 1, 1, 0> |
| 3 | <1, 1, 0, 1, 1, 0, 1, 1, 0, 1, 1, 0, 1, 1, 0, 1, 1, 0, 1, 1, 0, 1, 1, 0, 1, 1, 0, 1, 1, 0, 1, 1> |
| 4 | <0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0> |
| (Reserved) | |

The PHICH carries a HARQ (Hybrid Automatic Repeat Request) ACK/NACK (acknowledgment/negative-acknowledgment) signal as a response to UL transmission. The PHICH includes three REGs, and is scrambled cell-specifically. ACK/NACK is indicated by 1 bit, and the ACK/NACK of 1 bit is repeated three times. Each of the repeated ACK/NACK bits is spread with a spreading factor (SF) 4 or 2 and then mapped into a control region.

The control information transmitted through the PDCCH will be referred to as downlink control information (DCI). The DCI includes resource allocation information for a UE or UE group and other control information. Transmit format and resource allocation information of a downlink shared channel (DL-SCH) are referred to as DL scheduling information or DL grant. Transmit format and resource allocation information of an uplink shared channel (UL-SCH) are referred to as UL scheduling information or UL grant. The size and usage of the DCI carried by one PDCCH are varied depending on DCI formats. The size of the DCI may be varied depending on a coding rate. In the current 3GPP LTE system, various formats are defined, wherein formats 0 and 4 are defined for a UL, and formats 1, 1A, 1B, 1C, 1D, 2, 2A, 2B, 3 and 3A are defined for a DL. Combination selected from control information such as a hopping flag, RB allocation, modulation coding scheme (MCS), redundancy version (RV), new data indicator (NDI), transmit power control (TPC), cyclic shift, cyclic shift demodulation reference signal (DM RS), UL index, channel quality information (CQI) request, DL assignment index, HARQ process number, transmitted precoding matrix indicator (TPMI), precoding matrix indicator (PMI) information is transmitted to the UE as the DCI. The following table lists DCI formats.

TABLE 5

| DCI format | Description |
|---|---|
| 0 | Resource grants for the PUSCH transmissions (uplink) |
| 1 | Resource assignments for single codeword PDSCH transmissions |
| 1A | Compact signaling of resource assignments for single codeword PDSCH |
| 1B | Compact signaling of resource assignments for single codeword PDSCH |
| 1C | Very compact resource assignments for PDSCH (e.g. paging/broadcast system |
| | information) |
| 1D | Compact resource assignments for PDSCH using multi-user MIMO |
| 2 | Resource assignments for PDSCH for closed-loop MIMO operation |
| 2A | Resource assignments for PDSCH for open-loop MIMO operation |
| 2B | Resource assignments for PDSCH using up to 2 antenna ports with UE-specific |
| | reference signals |
| 2C | Resource assignment for PDSCH using up to 8 antenna ports with UE-specific |
| | reference signals |
| 3/3A | Power control commands for PUCCH and PUSCH with 2-bit/1-bit power |
| | adjustments |
| 4 | Scheduling of PUSCH in one UL Component Carrier with multi-antenna port |
| | transmission mode |

A plurality of PDCCHs may be transmitted within a control region. A UE may monitor the plurality of PDCCHs. An eNB determines a DCI format depending on the DCI to be transmitted to the UE, and attaches cyclic redundancy check (CRC) to the DCI. The CRC is masked (or scrambled) with an identifier (for example, a radio network temporary identifier (RNTI)) depending on usage of the PDCCH or owner of the PDCCH. For example, if the PDCCH is for a specific UE, the CRC may be masked with an identifier (for example, cell-RNTI (C-RNTI)) of the corresponding UE. If the PDCCH is for a paging message, the CRC may be masked with a paging identifier (for example, paging-RNTI (P-RNTI)). If the PDCCH is for system information (in more detail, system information block (SIB)), the CRC may be masked with system information RNTI (SI-RNTI). If the PDCCH is for a random access response, the CRC may be masked with a random access RNTI (RA-RNTI). For example, CRC masking (or scrambling) includes XOR operation of CRC and RNTI at the bit level.

The PDCCH is assigned to the first m OFDM symbol(s) in a subframe, wherein m is an integer equal to or greater than 1 and is indicated by a PCFICH.

The PDCCH is transmitted on an aggregation of one or a plurality of continuous control channel elements (CCEs). The CCE is a logic allocation unit used to provide a coding rate based on the status of a radio channel to the PDCCH. The CCE corresponds to a plurality of resource element groups (REGs). For example, one CCE corresponds to nine resource element groups (REGs), and one REG corresponds to four REs. Four QPSK symbols are mapped to each REG. A resource element (RE) occupied by the reference signal (RS) is not included in the REG. Accordingly, the number of REGs within given OFDM symbols is varied depending on the presence of the RS. The REGs are also used for other downlink control channels (that is, PDFICH and PHICH).

In a system, CCEs available for PDCCH transmission are numbered from 0 to N_{CCE}−1, wherein N_{CCE}=floor(N_{REG}/9) and N_{REG} denotes the number of REGs which are not allocated to a PCFICH or a PHICH.

A DCI format and the number of DCI bits are determined in accordance with the number of CCEs. The CCEs are numbered and consecutively used. To simplify the decoding process, a PDCCH having a format including n CCEs may be initiated only on CCEs assigned numbers corresponding to multiples of n. The number of CCEs used for transmission of a specific PDCCH is determined by a network or the eNB in accordance with channel status. For example, one CCE may be required for a PDCCH for a UE (for example, adjacent to eNB) having a good downlink channel. However, in case of a PDCCH for a UE (for example, located near the cell edge) having a poor channel, eight CCEs may be required to obtain sufficient robustness. Additionally, a power level of the PDCCH may be adjusted to correspond to a channel status.

An eNB transmits an actual PDCCH (DCI) on a PDCCH candidate in a search space and a UE monitors the search space to detect the PDCCH (DCI). Here, monitoring implies attempting to decode each PDCCH in the corresponding SS according to all monitored DCI formats. The UE may detect a PDCCH thereof by monitoring a plurality of PDCCHs. Basically, the UE does not know the location at which a PDCCH thereof is transmitted. Therefore, the UE attempts to decode all PDCCHs of the corresponding DCI format for each subframe until a PDCCH having an ID thereof is detected and this process is referred to as blind detection (or blind decoding (BD)).

For example, it is assumed that a specific PDCCH is CRC-masked with a radio network temporary identity (RNTI) “A” and information about data transmitted using a radio resource “B” (e.g. frequency location) and using transport format information “C” (e.g. transport block size, modulation scheme, coding information, etc.) is transmitted in a specific DL subframe. Then, the UE monitors the PDCCH using RNTI information thereof. The UE having the RNTI “A” receives the PDCCH and receives the PDSCH indicated by “B” and “C” through information of the received PDCCH.

FIG. 6 illustrates a resource unit used to configure a DL control channel.

FIG. 6(a) illustrates a resource unit when the number of transmission antenna ports is 1 or 2 and FIG. 6(b) illustrates a resource unit when the number of transmission antenna ports is 4. Only CRS patterns are different according to the number of transmission antennas and methods of configuring a resource unit related to a control channel are identical. Referring to FIG. 6, a resource unit for a control channel is an REG. The REG includes 4 neighboring REs excluding a CRS. That is, the REG includes REs except for REs indicated by any one of R0 to R3 in FIG. 6. A PFICH and a PHICH include 4 REGs and 3 REGs. A PDCCH is configured in units of CCEs each including 9 REGs. While REGs constituting a CCE are adjacent to each other in FIG. 6, 9 REGs constituting the CCE may be distributed on a frequency and/or time axis in a control region.

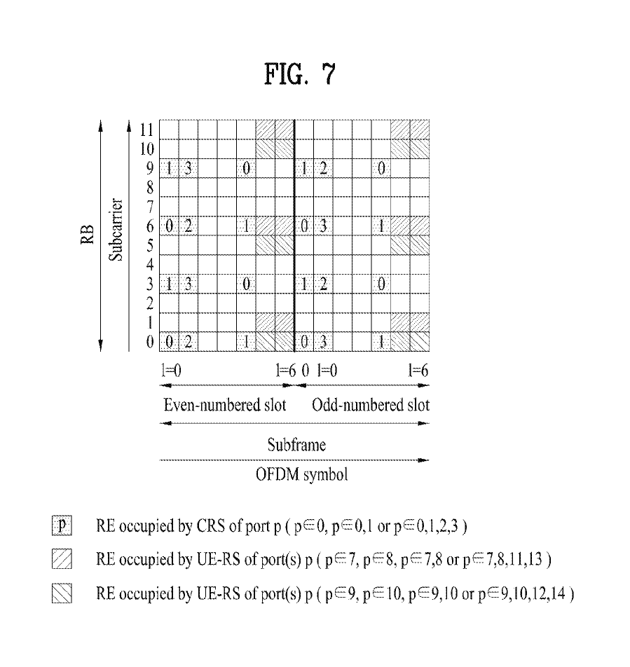

FIG. 7 illustrates configuration of cell specific reference signals (CRSs) and user specific reference signals (UE-RS). In particular, FIG. 7 shows REs occupied by the CRS(s) and UE-RS(s) on an RB pair of a subframe having a normal CP.

In an existing 3GPP system, since CRSs are used for both demodulation and measurement, the CRSs are transmitted in all DL subframes in a cell supporting PDSCH transmission and are transmitted through all antenna ports configured at an eNB.

Referring to FIG. 7, a CRS is transmitted through antenna port p=0, p=0, 1, or p=0, 1, 2, 3 according to the number of antenna ports of a transmission node. The CRS is fixed to a predetermined pattern in a subframe regardless of a control region and a data region. A control channel is allocated to a resource on which the CRS is not allocated in the control region and a data channel is allocated to a resource on which the CRS is not allocated in the data region.

A UE may measure CSI using the CRSs and demodulate a signal received on a PDSCH in a subframe including the CRSs. That is, the eNB transmits the CRSs at predetermined locations in each RB of all RBs and the UE performs channel estimation based on the CRSs and detects the PDSCH. For example, the UE may measure a signal received on a CRS RE and detect a PDSCH signal from an RE to which the PDSCH is mapped using the measured signal and using the ratio of reception energy per CRS RE to reception energy per PDSCH mapped RE. However, when the PDSCH is transmitted based on the CRSs, since the eNB should transmit the CRSs in all RBs, unnecessary RS overhead occurs. To solve such a problem, in a 3GPP LTE-A system, a UE-specific RS (hereinafter, UE-RS) and a CSI-RS are further defined in addition to a CRS. The UE-RS is used for demodulation and the CSI-RS is used to derive CSI. The UE-RS is one type of a DRS. Since the UE-RS and the CRS are used for demodulation, the UE-RS and the CRS may be regarded as demodulation RSs in terms of usage. Since the CSI-RS and the CRS are used for channel measurement or channel estimation, the CSI-RS and the CRS may be regarded as measurement RSs.

Referring to FIG. 7, UE-RSs are transmitted on antenna port(s) p=5, p=7, p=8 or p=7, 8, . . . , ν+6 for PDSCH transmission, where ν is the number of layers used for the PDSCH transmission. UE-RSs are present and are a valid reference for PDSCH demodulation only if the PDSCH transmission is associated with the corresponding antenna port. UE-RSs are transmitted only on RBs to which the corresponding PDSCH is mapped. That is, the UE-RSs are configured to be transmitted only on RB(s) to which a PDSCH is mapped in a subframe in which the PDSCH is scheduled unlike CRSs configured to be transmitted in every subframe irrespective of whether the PDSCH is present. Accordingly, overhead of the RS may be lowered compared to that of the CRS.

The CSI-RS is a DL RS introduced for channel measurement. In the 3GPP LTE-A system, a plurality of CSI-RS configurations is defined for CSI-RS transmission.

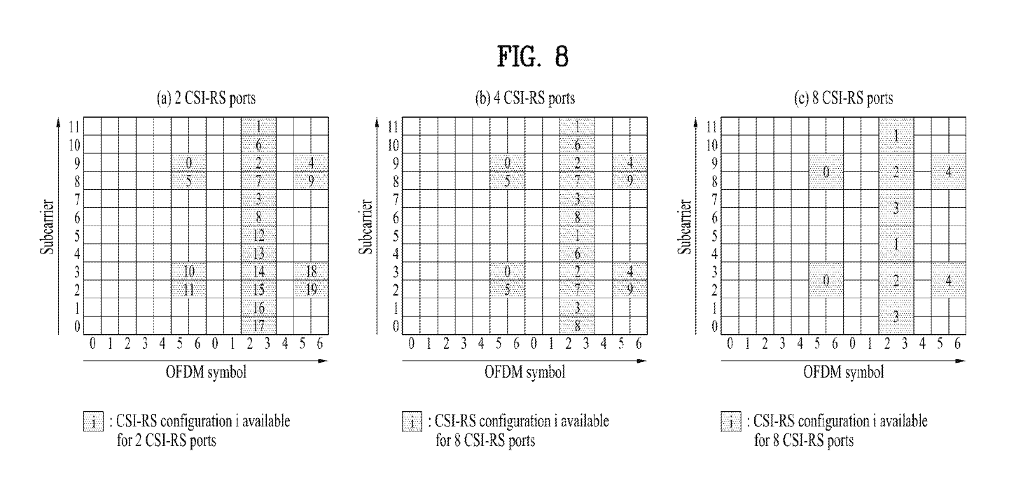

FIG. 8 illustrates CSI-RS configurations. Particularly, FIG. 8(a) illustrates 20 CSI-RS configurations 0 to 19 available for CSI-RS transmission through two CSI-RS ports among the CSI-RS configurations, FIG. 8(b) illustrates 10 available CSI-RS configurations 0 to 9 through four CSI-RS ports among the CSI-RS configurations, and FIG. 8(c) illustrates 5 available CSI-RS configurations 0 to 4 through 8 CSI-RS ports among the CSI-RS configurations. The CSI-RS ports refer to antenna ports configured for CSI-RS transmission. For example, referring to Equation 15, antenna ports 15 to 22 correspond to the CSI-RS ports. Since CSI-RS configuration differs according to the number of CSI-RS ports, if the numbers of antenna ports configured for CSI-RS transmission differ, the same CSI-RS configuration number may correspond to different CSI-RS configurations.

Unlike a CRS configured to be transmitted in every subframe, a CSI-RS is configured to be transmitted at a prescribed period corresponding to a plurality of subframes. Accordingly, CSI-RS configurations vary not only with the locations of REs occupied by CSI-RSs in an RB pair but also with subframes in which CSI-RSs are configured. That is, if subframes for CSI-RS transmission differ even when CSI-RS configuration numbers are the same, CSI-RS configurations also differ. For example, if CSI-RS transmission periods (T_{CSI-RS}) differ or if start subframes (Δ_{CSI-RS}) in which CSI-RS transmission is configured in one radio frame differ, this may be considered as different CSI-RS configurations. Hereinafter, in order to distinguish between a CSI-RS configuration to which a CSI-RS configuration number is assigned and a CSI-RS configuration varying according to a CSI-RS configuration number, the number of CSI-RS ports, and/or a CSI-RS configured subframe, the CSI-RS configuration of the latter will be referred to as a CSI-RS resource configuration.

When informing a UE of the CSI-RS resource configuration, an eNB may inform the UE of information about the number of antenna ports used for transmission of CSI-RSs, a CSI-RS pattern, CSI-RS subframe configuration I_{CSI-RS}, UE assumption on reference PDSCH transmitted power for CSI feedback P_{c}, a zero-power CSI-RS configuration list, a zero-power CSI-RS subframe configuration, etc.

CSI-RS subframe configuration I_{CSI-RS} is information for specifying subframe configuration periodicity T_{CSI-RS} and subframe offset Δ_{CSI-RS} regarding occurrence of the CSI-RSs. The following table shows CSI-RS subframe configuration I_{CSI-RS} according to T_{CSI-RS} and Δ_{CSI-RS}.

TABLE 6

| CSI-RS-SubframeConfig | CSI-RS periodicity | CSI-RS subframe offset |
|---|---|---|
| I_{CSI-RS} | T_{CSI-RS} (subframes) | Δ_{CSI-RS} (subframes) |
| 0-4 | 5 | I_{CSI-RS} |
| 5-14 | 10 | I_{CSI-RS}-5 |
| 15-34 | 20 | I_{CSI-RS}-15 |
| 35-74 | 40 | I_{CSI-RS}-35 |
| 75-154 | 80 | I_{CSI-RS}-75 |

Subframes satisfying {10n_{f}+floor(nₛ/2)-Δ_{CSI-RS}}modT_{CSI-RS}=0 are subframes including CSI-RSs, where n_{f} is a radio frame number, nₛ is a slot number in the radio frame.

P_{c} is the ratio of PDSCH EPRE to CSI-RS EPRE, assumed by the UE when the UE derives CSI for CSI feedback. EPRE indicates energy per RE. CSI-RS EPRE indicates energy per RE occupied by the CSI-RS and PDSCH EPRE denotes energy per RE occupied by a PDSCH.

The zero-power CSI-RS configuration list denotes CSI-RS pattern(s) in which the UE should assume zero transmission power. For example, since the eNB will transmit signals at zero transmission power on REs included in CSI-RS configurations indicated as zero transmission power in the zero power CSI-RS configuration list, the UE may assume signals received on the corresponding REs as interference or decode DL signals except for the signals received on the corresponding REs. The zero power CSI-RS configuration list may be a 16-bit bitmap corresponding one by one to 16 CSI-RS patterns for four antenna ports. In the 16-bit bitmap, the most significant bit corresponding to a CSI-RS configuration of the lowest CSI-RS configuration number (also called a CSI-RS configuration index) and subsequent bits correspond to CSI-RS patterns in an ascending order. The UE assumes zero transmission power with respect to REs of a CSI-RS pattern corresponding to bit(s) set to ‘1’ in the 16-bit zero power CSI-RS bitmap configured by a higher layer. Hereinafter, a CSI-RS pattern in which the UE assumes zero transmission power will be referred to as a zero power CSI-RS pattern.

A zero power CSI-RS subframe configuration is information for specifying subframes including the zero power CSI-RS pattern. Like the CSI-RS subframe configuration, a subframe in which the zero power CSI-RS occurs may be configured for the UE using I_{CSI-RS} according to Table 6. The UE may assume that subframes satisfying ‘{10n_{f}+floor(nₛ/2)-Δ_{CSI-RS}}modT_{CSI-RS}=0’ include the zero power CSI-RS pattern. I_{CSI-RS} may be separately configured with respect to a CSI-RA pattern in which the UE should assume non-zero transmission power and a zero power CSI-RS pattern in which the UE should assume zero transmission power, for REs.

The UE configured for a transmission mode (e.g. transmission mode 9 or other newly defined transmission modes) according to the 3GPP LTE-A system may perform channel measurement using a CSI-RS and demodulate or decode a PDSCH using a UE-RS.

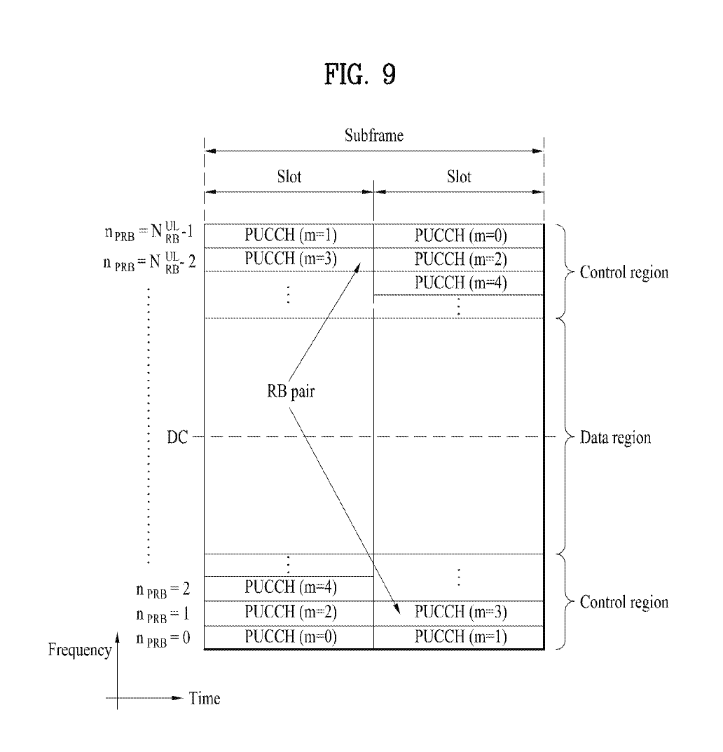

FIG. 9 illustrates the structure of a UL subframe used in a wireless communication system.

Referring to FIG. 9, a UL subframe may be divided into a data region and a control region in the frequency domain. One or several PUCCHs may be allocated to the control region to deliver UCI. One or several PUSCHs may be allocated to the data region of the UE subframe to carry user data.

In the UL subframe, subcarriers distant from a direct current (DC) subcarrier are used as the control region. In other words, subcarriers located at both ends of a UL transmission BW are allocated to transmit UCI. A DC subcarrier is a component unused for signal transmission and is mapped to a carrier frequency f₀ in a frequency up-conversion process. A PUCCH for one UE is allocated to an RB pair belonging to resources operating on one carrier frequency and RBs belonging to the RB pair occupy different subcarriers in two slots. The PUCCH allocated in this way is expressed by frequency hopping of the RB pair allocated to the PUCCH over a slot boundary. If frequency hopping is not applied, the RB pair occupies the same subcarriers.

The PUCCH may be used to transmit the following control information.
Scheduling request (SR): SR is information used to request a UL-SCH resource and is transmitted using an on-off keying (OOK) scheme.
HARQ-ACK: HARQ-ACK is a response to a PDCCH and/or a response to a DL data packet (e.g. a codeword) on a PDSCH. HARQ-ACK indicates whether the PDCCH or PDSCH has been successfully received. 1-bit HARQ-ACK is transmitted in response to a single DL codeword and 2-bit HARQ-ACK is transmitted in response to two DL codewords. A HARQ-ACK response includes a positive ACK (simply, ACK), negative ACK (NACK), discontinuous transmission (DTX), or NACK/DRX. HARQ-ACK is used interchangeably with HARQ ACK/NACK and ACK/NACK.
Channel state information (CSI): CSI is feedback information for a DL channel. CSI may include channel quality information (CQI), a precoding matrix indicator (PMI), a precoding type indicator, and/or a rank indicator (RI). In the CSI, MIMO-related feedback information includes the RI and the PMI. The RI indicates the number of streams or the number of layers that the UE can receive through the same time-frequency resource. The PMI is a value reflecting a space characteristic of a channel, indicating an index of a preferred precoding matrix for DL signal transmission based on a metric such as an SINR. The CQI is a value of channel strength, indicating a received SINR that can be obtained by the UE generally when the eNB uses the PMI.

For reference, HARQ used for error control in UL and/or DL will be described. HARQ-ACK transmitted in DL is used for error control with respect to UL data and HARQ-ACK transmitted in UL is used for error control with respect to DL data. In DL, an eNB schedules one or more RBs for a UE selected according to a predetermined scheduling rule and transmits data to the UE using the scheduled RBs. Hereinafter, scheduling information for DL transmission will be referred to as a DL grant and a PDCCH carrying the DL grant will be referred to as a DL grant PDCCH. In UL, the eNB schedules one or more RBs for a UE selected according to the predetermined scheduling rule and the UE transmits data in UL using allocated resources. A transmitting end performing a HARQ operation waits for an ACK signal after transmitting data (e.g. transport blocks or codewords). A receiving end performing the HARQ operation transmits an ACK signal only when the data is correctly received. On the other hand, when there is an error in the received data, the receiving end transmits a NACK signal. When receiving the ACK signal, the transmitting end transmits (new) data, but when receiving the NACK signal, the transmitting end retransmits the data. According to the HARQ scheme, error data is stored in a HARQ buffer and initial data is combined with retransmission data to increase a reception success rate.

The HARQ scheme is categorized as synchronous HARQ and asynchronous HARQ according to retransmission timing or as channel-adaptive HARQ and channel-non-adaptive HARQ depending upon whether a channel state is reflected in determination of the amount of retransmission resources.

In the synchronous HARQ scheme, if the initial transmission fails, retransmission is performed at timing determined by a system. For example, if it is assumed that retransmission is performed in every X-th (e.g. X=4) time unit (e.g. TTI, subframe, etc.) after the initial transmission fails, an eNB and a UE do not need to exchange information about retransmission timing. Therefore, when receiving a NACK message, the transmitting end may retransmit corresponding data in every fourth time unit until an ACK message is received. On the other hand, in the asynchronous HARQ scheme, retransmission timing is determined by new scheduling or additional signaling. That is, the retransmission timing for error data may be changed by various factors including a channel state and the like.

In the channel-non-adaptive HARQ scheme, a modulation and coding scheme (MCS), the number of RBs, etc., which are needed for retransmission, are the same as those used in the initial transmission. In contrast, in the channel-adaptive HARQ scheme, the MCS, the number of RBs, etc. for retransmission are changed according to channel states. For example, in the case of the channel-non-adaptive HARQ scheme, if the initial transmission is performed using 6 RBs, retransmission is also performed using 6 RBs. On the contrary, in the case of the channel-adaptive HARQ scheme, even if the initial transmission is performed using 6 RBs, retransmission may be performed using RBs less or greater than 6 RBs according to channel states.

Although any combination of the four HARQ schemes may be considered on the basis of such classification, an asynchronous/channel-adaptive HARQ scheme and a synchronous/channel-non-adaptive HARQ scheme are mainly used. According to the asynchronous/channel-adaptive HARQ scheme, the retransmission timing and the amount of retransmitted resources can be adaptively changed according to channel states, thereby maximizing retransmission efficiency. However, since overhead may be increased, this scheme is generally not considered in UL. Meanwhile, according to the synchronous/channel-non-adaptive HAQR scheme, since the retransmission timing and retransmission resource allocation are determined by the system, overhead almost does not occur. However, this scheme has a disadvantage in that retransmission efficiency is considerably decreased when the channel state is significantly changed. Thus, the current communication system uses the asynchronous HARQ scheme in DL and the synchronous HARQ scheme in UL.

A plurality of sub-packets used for the initial transmission and retransmission according to the HARQ scheme are generated from a single codeword packet. In this case, the plurality of the generated sub-packets can be distinguished from each other using a length and start position of each sub-packet. Such a distinguishable sub-packet is referred to as a redundancy version (RV) and RV information indicates a predetermined start point of each RB.

A transmitter transmits a sub-packet through a data channel in each HARQ transmission. In this case, a receiver generates an RV for the sub-packet in each HARQ transmission according to an order defined between the transmitting and receiving ends. Alternatively, the receiver creates an arbitrary RV and then transmits RV information through a control channel. The receiver maps the sub-packet received through the data channel to an accurate location of the codeword packet using the predetermined RV order or the RV information received through the control channel.

There may be a time delay until data retransmission is performed after completion of scheduling reception/transmission, data transmission/reception based on scheduling, ACK/NACK reception/transmission in response to data. Such a time delay occurs due to a channel propagation delay, a time required for data decoding/encoding, etc. That is, when new data is transmitted after completion of the current HARQ process, a gap occurs during the data transmission due to the time delay. To prevent the occurrence of the gap during the data transmission, a plurality of independent HARQ processes can be used. For example, if there is a gap consisting of 7 subframes between initial transmission and retransmission, data transmission can be performed using 7 independent HARQ processes for the purpose of removing the gap. In the case of a plurality of parallel HARQ processes, UL/DL transmission can be continuously performed until HARQ feedback in response to previous UL/DL transmission is received. Each of the HARQ processes is associated with a HARQ buffer in a medium access control (MAC) layer and manages state variables regarding the number of transmission times of an MAC physical data block (PDU) in the buffer, HARQ feedback for the MAC PDU in the buffer, the current RV, and the like.

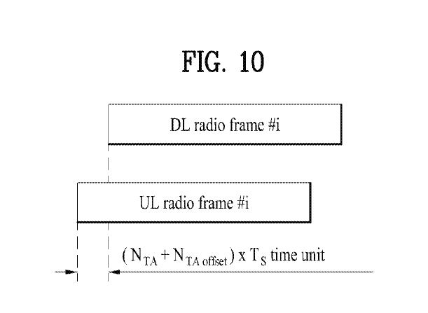

FIG. 10 illustrates a UL-DL frame timing relationship.

Referring to FIG. 10, a UE starts to transmit UL radio frame i (N_{TA}±N_{TAoffset})*Tₛ seconds earlier than a corresponding DL radio frame. Here, N_{TA} indicates a timing offset between UL and DL radio frames in the UE, expressed in units of Tₛ. N_{TAoffset} indicates a fixed timing advance offset expressed in units of Tₛ. In an LTE system, 0≦N_{TA}≦20512, N_{TAoffset}=0 in FDD, and N_{TAoffset}=624 in TDD. N_{TAoffset} is a value pre-recognized by an eNB and a UE. If N_{TA} is indicated by a timing advance command (TAC) in a random access procedure, the UE adjusts the transmission timing of a UL signal (e.g. a PUCCH/PUSCH/SRS) by the above equation. The UL transmission timing is set to a multiple of 16Tₛ. Tₛ is a sampling time, for example, 1/30720 (ms) (refer to FIG. 2). The TAC indicates variation of a UL timing based on a current UL timing. A TAC T_{A} in an RAR is 11 bits, indicating a value ranging from 0 to 1282 and a timing adjustment value N_{TA} is given as N_{TA}=T_{A}*16. Otherwise, the TAC T_{A} is 6 bits, indicating a value ranging from 0 to 63 and the timing adjustment value N_{TA} is given as N_{TA,new}=N_{TA,old} (T_{A}−31)*16. A TAC received in subframe n is applied after subframe n+6. In FDD, the transmission timing of UL subframe n is advanced based on the start timing of DL subframe n as illustrated in FIG. 10. On the other hand, in TDD, the transmission timing of UL subframe n is advanced based on the end timing of DL subframe n+1 (not shown).

A general wireless communication system transmits/receives data through one downlink (DL) band and through one uplink (UL) band corresponding to the DL band (in the case of frequency division duplex (FDD) mode), or divides a prescribed radio frame into a UL time unit and a DL time unit in the time domain and transmits/receives data through the UL/DL time unit (in the case of time division duplex (TDD) mode). Recently, to use a wider frequency band in recent wireless communication systems, introduction of carrier aggregation (or BW aggregation) technology that uses a wider UL/DL BW by aggregating a plurality of UL/DL frequency blocks has been discussed. A carrier aggregation (CA) is different from an orthogonal frequency division multiplexing (OFDM) system in that DL or UL communication is performed using a plurality of carrier frequencies, whereas the OFDM system carries a base frequency band divided into a plurality of orthogonal subcarriers on a single carrier frequency to perform DL or UL communication. Hereinbelow, each of carriers aggregated by carrier aggregation will be referred to as a component carrier (CC).

For example, three 20 MHz CCs in each of UL and DL are aggregated to support a BW of 60 MHz. The CCs may be contiguous or non-contiguous in the frequency domain. Although it is assumed that the BWs of the UL CCs are equal to and symmetrical with those of the DL CCs for convenience of description, the BWs of the individual CCs can be independently configured. In addition, asymmetric carrier aggregation where the number of UL CCs is different from the number of DL CCs may be configured. A DL/UL CC for a specific UE may be referred to as a serving UL/DL CC configured at the specific UE.

In the meantime, the 3GPP LTE-A system uses a concept of “cell” to manage radio resources. The cell is defined by combination of downlink resources and uplink resources, that is, combination of DL CC and UL CC. The cell may be configured by downlink resources only, or may be configured by downlink resources and uplink resources. If carrier aggregation is supported, linkage between a carrier frequency of the downlink resources (or DL CC) and a carrier frequency of the uplink resources (or UL CC) may be indicated by system information. For example, combination of the DL resources and the UL resources may be indicated by linkage of system information block type 2 (SIB2). In this case, the carrier frequency means a center frequency of each cell or CC. A cell operating on a primary frequency may be referred to as a primary cell (Pcell) or PCC, and a cell operating on a secondary frequency may be referred to as a secondary cell (Scell) or SCC. The carrier corresponding to the Pcell on downlink will be referred to as a downlink primary CC (DL PCC), and the carrier corresponding to the Pcell on uplink will be referred to as an uplink primary CC (UL PCC). A Scell means a cell that may be configured after completion of radio resource control (RRC) connection establishment and used to provide additional radio resources. The Scell may form a set of serving cells for the UE together with the Pcell in accordance with capabilities of the UE. The carrier corresponding to the Scell on the downlink will be referred to as downlink secondary CC (DL SCC), and the carrier corresponding to the Scell on the uplink will be referred to as uplink secondary CC (UL SCC). Although the UE is in RRC-CONNECTED state, if it is not configured by carrier aggregation or does not support carrier aggregation, a single serving cell configured by the Pcell only exists.

The eNB may activate all or some of the serving cells configured in the UE or deactivate some of the serving cells for communication with the UE. The eNB may change the activated/deactivated cell, and may change the number of cells which is/are activated or deactivated. If the eNB allocates available cells to the UE cell-specifically or UE-specifically, at least one of the allocated cells is not deactivated unless cell allocation to the UE is fully reconfigured or unless the UE performs handover. Such a cell which is not deactivated unless CC allocation to the UE is full reconfigured will be referred to as Pcell, and a cell which may be activated/deactivated freely by the eNB will be referred to as Scell. The Pcell and the Scell may be identified from each other on the basis of the control information. For example, specific control information may be set to be transmitted and received through a specific cell only. This specific cell may be referred to as the Pcell, and the other cell(s) may be referred to as Scell(s).

A configured cell refers to a cell in which CA is performed for a UE based on measurement report from another eNB or UE among cells of an eNB and is configured for each UE. The configured cell for the UE may be a serving cell in terms of the UE. The configured cell for the UE, i.e. the serving cell, pre-reserves resources for ACK/NACK transmission for PDSCH transmission. An activated cell refers to a cell configured to be actually used for PDSCH/PUSCH transmission among configured cells for the UE and CSI reporting and SRS transmission for PDSCH/PUSCH transmission are performed on the activated cell. A deactivated cell refers to a cell configured not to be used for PDSCH/PUSCH transmission by the command of an eNB or the operation of a timer and CSI reporting and SRS transmission are stopped on the deactivated cell.

For reference, a carrier indicator (CI) means a serving cell index ServCellIndex and CI=0 is applied to a Pcell. The serving cell index is a short identity used to identify the serving cell and, for example, any one of integers from 0 to ‘maximum number of carrier frequencies which can be configured for the UE at a time minus 1’ may be allocated to one serving cell as the serving cell index. That is, the serving cell index may be a logical index used to identify a specific serving cell among cells allocated to the UE rather than a physical index used to identify a specific carrier frequency among all carrier frequencies.

As described above, the term “cell” used in carrier aggregation is differentiated from the term “cell” indicating a certain geographical area where a communication service is provided by one eNB or one antenna group.

The cell mentioned in the present invention means a cell of carrier aggregation which is combination of UL CC and DL CC unless specifically noted.

Meanwhile, since one serving cell is only present in case of communication based on a single carrier, a PDCCH carrying UL/DL grant and corresponding PUSCH/PDSCH are transmitted on one cell. In other words, in case of FDD under a single carrier environment, a PDCCH for a DL grant for a PDSCH, which will be transmitted on a specific DL CC, is transmitted on the specific CC, and a PDCCH for a UL grant for a PUSCH, which will be transmitted on a specific UL CC, is transmitted on a DL CC linked to the specific UL CC. In case of TDD under a single carrier environment, a PDCCH for a DL grant for a PDSCH, which will be transmitted on a specific DL CC, is transmitted on the specific CC, and a PDCCH for a UL grant for a PUSCH, which will be transmitted on a specific UL CC, is transmitted on the specific CC.

On the contrary, since a plurality of serving cells may be configured in a multi-carrier system, transmission of UL/DL grant through a serving cell having a good channel status may be allowed. In this way, if a cell carrying UL/DL grant which is scheduling information is different from a cell where UL/DL transmission corresponding to the UL/DL grant is performed, this will be referred to as cross-carrier scheduling.

Hereinafter, the case where the cell is scheduled from itself and the case where the cell is scheduled from another cell will be referred to as self-CC scheduling and cross-CC scheduling, respectively.

For data transmission rate enhancement and stable control signaling, the 3GPP LTE/LTE-A may support aggregation of a plurality of CCs and a cross carrier-scheduling operation based on the aggregation.

If cross-carrier scheduling (or cross-CC scheduling) is applied, a PDCCH for downlink allocation for a DL CC B or DL CC C, that is, carrying a DL grant may be transmitted through a DL CC A, and a corresponding PDSCH may be transmitted through the DL CC B or DL CC C. For cross-CC scheduling, a carrier indicator field (CIF) may be introduced. The presence or absence of the CIF within the PDCCH may be semi-statically and UE-specifically (or UE-group-specifically) configured by higher layer signaling (e.g., RRC signaling).

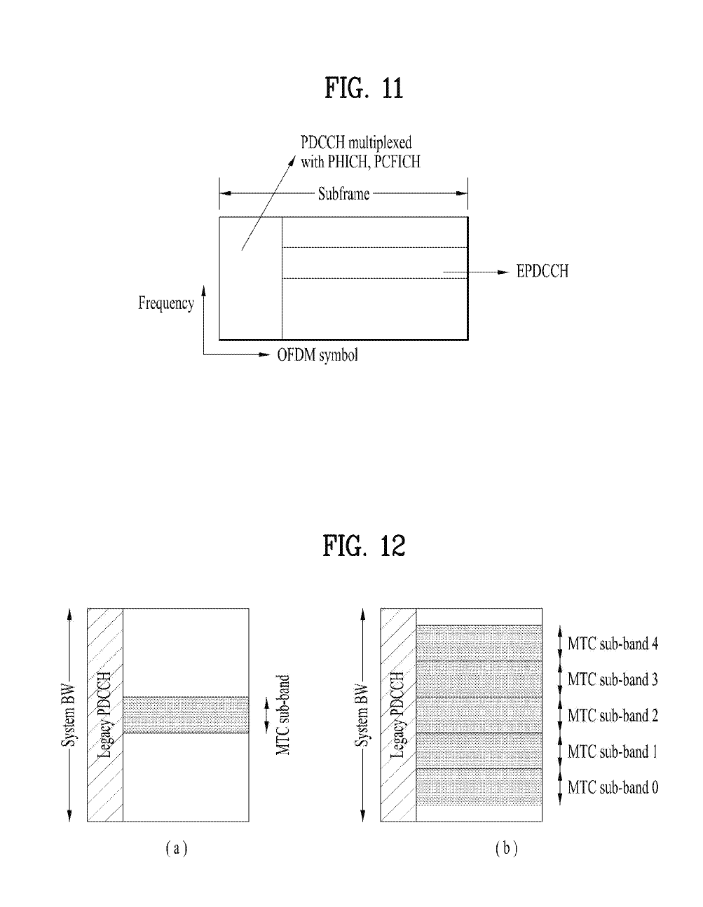

FIG. 11 is an example of a downlink control channel configured in a data region of a DL subframe.

Meanwhile, if RRH technology, cross-carrier scheduling technology, etc. are introduced, the amount of PDCCH which should be transmitted by the eNB is gradually increased. However, since a size of a control region within which the PDCCH may be transmitted is the same as before, PDCCH transmission acts as a bottleneck of system throughput. Although channel quality may be improved by the introduction of the aforementioned multi-node system, application of various communication schemes, etc., the introduction of a new control channel is required to apply the legacy communication scheme and the carrier aggregation technology to a multi-node environment. Due to the need, a configuration of a new control channel in a data region (hereinafter, referred to as PDSCH region) not the legacy control region (hereinafter, referred to as PDCCH region) has been discussed. Hereinafter, the new control channel will be referred to as an enhanced PDCCH (hereinafter, referred to as EPDCCH)

The EPDCCH may be configured within rear OFDM symbols starting from a configured OFDM symbol, instead of front OFDM symbols of a subframe. The EPDCCH may be configured using continuous frequency resources, or may be configured using discontinuous frequency resources for frequency diversity. By using the EPDCCH, control information per node may be transmitted to a UE, and a problem that a legacy PDCCH region may not be sufficient may be solved. For reference, the PDCCH may be transmitted through the same antenna port(s) as that(those) configured for transmission of a CRS, and a UE configured to decode the PDCCH may demodulate or decode the PDCCH by using the CRS. Unlike the PDCCH transmitted based on the CRS, the EPDCCH is transmitted based on the demodulation RS (hereinafter, DMRS). Accordingly, the UE decodes/demodulates the PDCCH based on the CRS and decodes/demodulates the EPDCCH based on the DMRS. The DMRS associated with EPDCCH is transmitted on the same antenna port pε{107,108,109,110} as the associated EPDCCH physical resource, is present for EPDCCH demodulation only if the EPDCCH transmission is associated with the corresponding antenna port, and is transmitted only on the PRB(s) upon which the corresponding EPDCCH is mapped. For example, the REs occupied by the UE-RS(s) of the antenna port 7 or 8 may be occupied by the DMRS(s) of the antenna port 107 or 108 on the PRB to which the EPDCCH is mapped, and the REs occupied by the UE-RS(s) of antenna port 9 or 10 may be occupied by the DMRS(s) of the antenna port 109 or 110 on the PRB to which the EPDCCH is mapped. In other words, a certain number of REs are used on each RB pair for transmission of the DMRS for demodulation of the EPDCCH regardless of the UE or cell if the type of EPDCCH and the number of layers are the same, as in the case of the UE-RS for demodulation of the PDSCH.

For each serving cell, higher layer signaling can configure a UE with one or two EPDCCH-PRB-sets for EPDCCH monitoring. The PRB-pairs corresponding to an EPDCCH-PRB-set are indicated by higher layers. Each EPDCCH-PRB-set consists of set of ECCEs numbered from 0 to N_{ECCE,p,k}−1, where N_{ECCE,p,k} is the number of ECCEs in EPDCCH-PRB-set p of subframe k. Each EPDCCH-PRB-set can be configured for either localized EPDCCH transmission or distributed EPDCCH transmission.

The UE shall monitor a set of EPDCCH candidates on one or more activated serving cells as configured by higher layer signaling for control information.

The set of EPDCCH candidates to monitor are defined in terms of EPDCCH UE-specific search spaces. For each serving cell, the subframes in which the UE monitors EPDCCH UE-specific search spaces are configured by higher layers.

The UE does not monitor an EPDCCH in the following subframes:
in the case of TDD and a normal DL CP, special subframes for special subframe configurations 0 and 5 of Table 2;
in the case of TDD and an extended DL CP, subframes for special subframe configurations 0, 4 and 7 of Table 2;
subframes indicated to decode a physical multicast channel (PMCH) by higher layers; and
special subframes corresponding to DL subframes on a Pcell when the UE is configured as UL/DL configurations for the Pcell and an Scell and the same DL subframes on the Scell when the UE cannot perform simultaneous transmission and reception on the Pcell and the Scell.

An EPDCCH UE-specific search space ES^{(L)}ₖ at aggregation level Lε{1,2,4,8,16,32} is defined by a set of EPDCCH candidates. For an EPDCCH-PRB-set p configured for distributed transmission, the ECCEs corresponding to EPDCCH candidate m of the search space ES^{(L)}ₖ are given by the following table.

L{Y_{p,k}+m′)mod└N_{ECCEp,k}/L┘}+i Equation 1

For an EPDCCH-PRB-set p configured for localised transmission, the ECCEs corresponding to EPDCCH candidate m of the search space ES^{(L)}ₖ are given Equation 2

$$L \{ ( {Y}_{p , k} + ⌊ \frac{m \cdot {N}_{ECCE , p , k}}{L \cdot {M}_{p}^{( L )}} ⌋ + b ) mod ⌊ {N}_{ECCE , p , k} / L ⌋ \} + i \qquad Equation 2$$

where i=0, . . . , L−1. b=n_{CI} if the UE is configured with a carrier indicator field for the serving cell on which EPDCCH is monitored, otherwise b=0. n_{CI} is the carrier indicator field (CIF) value, which is the same as a serving cell index (ServCellIndex). m=0, 1, . . . M^{(L)}ₚ−1, M^{(L)}ₚ is the number of EPDCCH candidates to monitor at aggregation level L in EPDCCH-PRB-set p. The variable Y_{p,k} is defined by ‘Y_{p,k}=(Aₚ·Y_{p,k-1}) mod D’, where Y_{p,k-1}=n_{RNTI}≠A₀=39827, A₀=39829, D=65537 and k=floor(nₛ/2). nₛ is the slot number within a radio frame.

A UE is not expected to monitor an EPDCCH candidate, if an ECCE corresponding to that EPDCCH candidate is mapped to a PRB pair that overlaps in frequency with a transmission of either PBCH or PSS/SSS in the same subframe.

An EPDCCH is transmitted using an aggregation of one or several consecutive enhanced control channel elements (ECCEs). Each ECCE consists of multiple enhanced resource element groups (EREGs). EREGs are used for defining the mapping of enhanced control channels to resource elements. There are 16 EREGs, numbered from 0 to 15, per physical resource block (PRB) pair. Number all resource elements (REs), except resource elements carrying DMRS (hereinafter, EPDCCH DMRS) for demodulation of the EPDCCH, in a physical resource-block pair cyclically from 0 to 15 in an increasing order of first frequency. Therefore, all the REs, except REs carrying the EPDCCH DMRS, in the PRB pair has any one of numbers 0 to 15. All REs with number i in that PRB pair constitutes EREG number i. As described above, it is noted that EREGs are distributed on frequency and time axes within the PRB pair and an EPDCCH transmitted using aggregation of one or more ECCEs, each of which includes a plurality of EREGs, is also distributed on frequency and time axes within the PRB pair.

The number of ECCEs used for one EPDCCH depends on the EPDCCH format as given by Table 7, the number of EREGs per ECCE is given by Table 8. Table 7 shows an example of supported EPDCCH formats, and Table 8 shows an example of the number of EREGs per ECCE, N^{EREG}_{ECCE}. Both localized and distributed transmission is supported.

TABLE 7

| | Number of ECCEs for one EPDCCH, N^{ECCE}_{EPDCCH} | | | |
|---|---|---|---|---|
| | Case A | | Case B | |
| EPDCCH | Localized | Distributed | Localized | Distributed |
| format | transmission | transmission | transmission | transmission |
| 0 | 2 | 2 | 1 | 1 |
| 1 | 4 | 4 | 2 | 2 |
| 2 | 8 | 8 | 4 | 4 |
| 3 | 16 | 16 | 8 | 8 |
| 4 | — | 32 | — | 16 |

TABLE 8

| Normal cyclic prefix | | | Extended cyclic prefix | |
|---|---|---|---|---|
| | Special | | | Special |
| | subframe, | Special subframe, | | subframe, |
| Normal | configuration | configuration | Normal | configuration |
| subframe | 3, 4, 8 | 1, 2, 6, 7, 9 | subframe | 1, 2, 3, 5, 6 |

| | |
|---|---|
| 4 | 8 |

An EPDCCH can use either localized or distributed transmission, differing in the mapping of ECCEs to EREGs and PRB pairs. One or two sets of PRB pairs which a UE shall monitor for EPDCCH transmissions can be configured. All EPDCCH candidates in EPDCCH set Sₚ (i.e., EPDCCH-PRB-set) use either only localized or only distributed transmission as configured by higher layers. Within EPDCCH set Sₚ in subframe k, the ECCEs available for transmission of EPDCCHs are numbered from 0 to N_{ECCE,p,k}−1. ECCE number n is corresponding to the following EREG(s):
EREGs numbered (n mod N^{ECCE}_{RB})+jN^{ECCE}_{RB} RB) in PRB index floor(n/N^{ECCE}_{RB}) for localized mapping, and
EREGs numbered floor (n/N^{Sm}_{RB})+jN^{ECCE}_{RB} in PRB indices (n+jmax(1,N^{Sp}_{RB}/N^{EREG}_{ECCE}))modN^{Sp}_{RB} for distributed mapping,

where j=0, 1, . . . , N^{EREG}_{ECCE}−1, N^{EREG}_{ECCE} is the number of EREGs per ECCE, and N^{ECCE}_{RB}=16/N^{EREG}_{ECCE} is the number of ECCEs per RB pair. The PRB pairs constituting EPDCCH set Sₚ are assumed to be numbered in ascending order from 0 to N^{Sp}_{RB}−1.

Case A in Table 7 applies when:
DCI formats 2, 2A, 2B, 2C or 2D is used and N^{DL}_{RB}≧25, or
any DCI format when n_{EPDCCH}<104 and normal cyclic prefix is used in normal subframes or special subframes with configuration 3, 4, 8.

Otherwise case B is used. The quantity n_{EPDCCH} for a particular UE is defined as the number of downlink resource elements (k,l) in a PRB pair configured for possible EPDCCH transmission of EPDCCH set S₀ and and fulfilling all of the following criteria,
they are part of any one of the 16 EREGs in the physical resource-block pair,
they are assumed by the UE not to be used for CRSs or CSI-RSs,
the index l in a subframe fulfils l≧l_{EPDCCHStart}.

where l_{EPDCCHStart} is given based on higher layer signaling ‘epdcch-StartSymbol-r11’, higher layer signaling ‘pdsch-Start-r11’, or CFI value carried by PCFICH.

The mapping to resource elements (k,l) on antenna port p meeting the criteria above is in increasing order of first the index k and then the index l, starting with the first slot and ending with the second slot in a subframe.

For localized transmission, the single antenna port p to use is given by TABLE 11 with n′=n_{ECCE,low} mod N^{ECCE}_{RB}+n_{RNTI} mod min(N^{ECCE}_{EPDCCH},N^{ECCE}_{RB}), where n_{ECCE,low} is the lowest ECCE index used by this EPDCCH transmission in the EPDCCH set, n_{RNTI} corresponds to the RNTI associated with the EPDCCH transmission, and N^{ECCE}_{EPDCCH} is the number of ECCEs used for this EPDCCH.

TABLE 9

| | Normal cyclic prefix | | |
|---|---|---|---|
| | Normal subframes, | | Extended |
| | Special subframes, | Special subframes, | cyclic prefix |
| n′ | configurations 3, 4, 8 | configurations 1, 2, 6, 7, 9 | Any subframe |
| 0 | 107 | 107 | 107 |
| 1 | 108 | 109 | 108 |
| 2 | 109 | — | — |
| 3 | 110 | — | — |

For distributed transmission, each resource element in an EREG is associated with one out of two antenna ports in an alternating manner where pε{107,109} for normal cyclic prefix and pε{107,108} for extended cyclic prefix.

Recently, machine type communication (MTC) has come to the fore as a significant communication standard issue. MTC refers to exchange of information between a machine and an eNB without involving persons or with minimal human intervention. For example, MTC may be used for data communication for measurement/sensing/reporting such as meter reading, water level measurement, use of a surveillance camera, inventory reporting of a vending machine, etc. and may also be used for automatic application or firmware update processes for a plurality of UEs. In MTC, the amount of transmission data is small and UL/DL data transmission or reception (hereinafter, transmission/reception) occurs occasionally. In consideration of such properties of MTC, it would be better in terms of efficiency to reduce production cost and battery consumption of UEs for MTC (hereinafter, MTC UEs) according to data transmission rate. Since the MTC UE has low mobility, the channel environment thereof remains substantially the same. If an MTC UE is used for metering, reading of a meter, surveillance, and the like, the MTC UE is very likely to be located in a place such as a basement, a warehouse, and mountain regions which the coverage of a typical eNB does not reach. In consideration of the purposes of the MTC UE, it is better for a signal for the MTC UE to have wider coverage than the signal for the conventional UE (hereinafter, a legacy UE).

When considering the usage of the MTC UE, there is a high probability that the MTC UE requires a signal of wide coverage compared with the legacy UE. Therefore, if the eNB transmits a PDCCH, a PDSCH, etc. to the MTC UE using the same scheme as a scheme of transmitting the PDCCH, the PDSCH, etc. to the legacy UE, the MTC UE has difficulty in receiving the PDCCH, the PDSCH, etc. Therefore, the present invention proposes that the eNB apply a coverage enhancement scheme such as subframe repetition (repetition of a subframe with a signal) or subframe bundling upon transmission of a signal to the MTC UE having a coverage issue so that the MTC UE can effectively receive a signal transmitted by the eNB. For example, the PDCCH and PDSCH may be transmitted to the MTC UE having the coverage issue in a plurality of subframes (e.g. about 100 subframes).

Since embodiments of the present invention described hereinbelow relate to methods for coverage enhancement, the present invention may be applied not only to the MTC UE but also to other UEs having the coverage issue. Therefore, the embodiments of the present invention are applicable to a UE operating in a coverage enhancement mode. However, for convenience of description, a UE configured to implement a coverage enhancement method according to the present invention will be referred to as the MTC UE and a UE configured not to implement the coverage enhancement method according to the present invention will be referred to as a legacy UE.

Before describing the embodiments of the present invention, the terms used in the following description are explained in brief.

Scheduling: a network (e.g. eNB) can dynamically allocate resources (e.g. PRB and MCS) to UE(s) at each subframe through a C-RNTI on a PDCCH and/or EPDCCH (hereinafter referred to as PDCCH/EPDCCH) and a UE monitors PDCCH(s)/EPDCCH(s) in order to find possible allocation for UL transmission or DL reception

Semi-persistent scheduling (SPS): the SPS means that resources available during a relatively long time period are configured rather than one-time resources used for the PDCCH/EPDCCH. The network can allocate semi-persistent DL resources and/or semi-persistent UL resources to UE(s). When the SPS is enabled through radio resource control (RRC), the following information is provided:
SPS C-RNTI;
UL SPS interval and the number of empty transmissions before implicit release when SPS for UL is enabled; and
DL SPS interval and the number of HARQ processes configured for SPS when SPS for DL is enabled;

The RRC defines the periodicity of a semi-persistent grant and the PDCCH/EPDCCH indicates whether the corresponding (DL or UL) grant is a semi-persistent one, i.e. whether it can be implicitly reused in the following subframes according to the periodicity defined by the RRC. In the subframes where the UE has semi-persistent resources, if the UE cannot find its C-RNTI on the PDCCH/EPDCCH, transmission according to semi-persistent allocation that the UE has been assigned in the corresponding subframe is assumed. On the other hand, in the subframes where the UE has the semi-persistent resources, if the UE finds its C-RNTI on the PDCCH/EPDCCH, allocation for the PDCCH/EDPCCH takes priority over the semi-persistent allocation for the corresponding subframe and the UE does not decode the semi-persistent allocation.

If CRC parity bits obtained for PDCCH/EPDCCH payload are scrambled with a SPS C-RNTI and a new data indicator (NDI) field is set to ‘0’, the UE validates a SPS assignment PDCCH/EDPCCH. If all the fields for used a DCI format are set according to Table 10 or Table 11 described below, validation is achieved. In case of DCI formats 2, 2A, 2B, 2C, and 2D, the NDI field refers to the one for enabled transport blocks.

Table 10 shows special fields for SPS activation PDCCH/EPDCCH validation and Table 11 shows special fields for SPS release PDCCH/EPDCCH validation.

TABLE 10

| | DCI | DCI format | DCI format |
|---|---|---|---|
| | format 0 | 1/1A | 2/2A/2B/2C/2D |
| TPC command | set to ‘00’ | N/A | N/A |
| for scheduled | | | |
| PUSCH | | | |
| Cyclic shift DM | set to ‘000’ | N/A | N/A |
| RS | | | |
| Modulation and | MSB is set | N/A | N/A |
| coding scheme | to ‘0’ | | |
| and redundancy | | | |
| version | | | |
| HARQ process | N/A | FDD: set to | FDD: set to ‘000’ |
| number | | ‘000’ | TDD: set to ‘0000’ |
| | | TDD: set to | |
| | | ‘0000’ | |
| Modulation and | N/A | MSB is set | For the enabled transport |
| coding scheme | | to ‘0’ | block: MSB is set to ‘0’ |
| Redundancy | N/A | set to ‘00’ | For the enabled transport |
| version | | | block: set to ‘00’ |

TABLE 11

| | | DCI format |
|---|---|---|
| | DCI format 0 | 1A |
| TPC command for scheduled PUSCH | set to ‘00’ | N/A |
| Cyclic shift DM RS | set to ‘000’ | N/A |
| Modulation and coding scheme | set to ‘11111’ | N/A |
| and redundancy version | | |
| Resource block assignment | Set to all ‘1’s | N/A |
| and hopping resource allocation | | |
| HARQ process number | N/A | FDD: set to |
| | | ‘000’ |
| | | TDD: set to |
| | | ‘0000’ |
| Modulation and coding scheme | N/A | set to ‘11111’ |
| Redundancy version | N/A | set to all ‘1’s |

If validation is achieved, the UE considers the received DCI information accordingly as a valid SPS activation or release. If validation is not achieved, the received DCI format is considered by the UE as having been received with a non-matching CRC.

When the DCI format indicates SPS DL scheduling activation, a TPC command value for a PUCCH field may be used as an index for indicating one of four resources configured by a higher layer.

When the SPS for UL or DL is disabled by the RRC, the corresponding configured grant or configured assignment may be discarded. If a UE is not configured to operate in dual connectivity (DC), the SPS is supported on the PCell only. If a UE is configured to operate in a master cell group (MCG) and a secondary cell group (SCG), i.e., the UE is configured to operate in the DC, the SPS is supported on the PCell belonging to the MCG and a special SCell belonging to the SCG, i.e., the PCell of the SCG only.

PDSCH: this means a DL grant PDCCH or EPDCCH (hereinafter referred to as PDCCH/EPDCCH). The PDSCH is interchangeably used with a PDSCH with the PDCCH/EPDCCH in the specification.

SPS release PDCCH: this means a PDCCH indicating SPS release.

SPS PDSCH: this means a PDSCH transmitted in DL using resources semi-statically configured by the SPS. The SPS PDSCH has no DL grant PDCCH/EPDCCH corresponding thereto. The SPS PDSCH is interchangeably used with a PDSCH without the PDCCH/EPDCCH in the specification.

SPS PUSCH: this means a PUSCH transmitted in UL using resources semi-statically configured by the SPS. The SPS PUSCH has no UL grant PDCCH/EPDCCH corresponding thereto. The SPS PUSCH is interchangeably used with a PUSCH without the PDCCH/EPDCCH in the specification.

PUCCH index: this corresponds to a PUCCH resource. The PUCCH index indicates, for example, a PUCCH resource index. The PUCCH resource index is mapped to at least one of orthogonal cover (OC), cyclic shift (CS), and PRB.

FIG. 12 illustrates an exemplary signal band for MTC.

As one method of reducing the cost of an MTC UE, the MTC UE may operate in, for example, a reduced DL and UL bandwidths of 1.4 MHz regardless of the system bandwidth when the cell operates. In this case, a sub-band (i.e., narrowband) in which the MTC UE operates may always be positioned at the center of a cell (e.g., 6 center PRBs) as shown in FIG. 12(a), or multiple sub-bands for MTC may be provided in one subframe to multiplex MTC UEs in the subframe such that the UEs use different sub-bands or use the same sub-band which is not a sub-band consisting of the 6 center PRBs as shown in FIG. 12(b).

In this case, the MTC UE may not normally receive a legacy PDCCH transmitted through the entire system bandwidth, and therefore it may not be preferable to transmit a PDCCH for the MTC UE in an OFDM symbol region in which the legacy PDCCH is transmitted, due to an issue of multiplexing with a PDCCH transmitted for another UE. As one method to address this issue, introduction of a control channel transmitted in a sub-band in which MTC operates for the MTC UE is needed. As a DL control channel for such low-complexity MTC UE, a legacy EPDCCH may be used. Alternatively, an M-PDCCH, which is a variant of the legacy EPDCCH, may be introduced for the MTC UE.

In this document, a physical DL control channel for a low-complexity or normal-complexity MTC UE is referred to as an EPDCCH, M-PDCCH or MTC-PDCCH. In other words, the EPDCCH, M-PDCCH, and MTC-PDCCH can be interchangeably used as a term indicating the physical DL control channel transmitted in a data region consisting of subframes for the low-complexity UE or normal (MTC) UE.

While a description of the present invention is given based on the assumption that a DL control channel proposed in the present invention is used for MTC UEs, the present invention is applicable even to the case in which the proposed DL control channel is used for normal UEs other than the MTC UEs.

Hereinafter, a description will be given of operation of the low-complexity MTC UE capable of receiving only a single PDSCH at a time when a plurality of PDSCHs are allocated to the MTC UE.

<A. Priority Rule in Case of Channel Collision>

To minimize UE complexity, particularly for a UE operating in coverage enhancement mode where a channel is transmitted using a plurality of subframes, the UE may encounter the situation where multiple channels are simultaneously transmitted or bundles of multiple channels partially or entirely overlap each other at a time.

In this specification, channels are defined as follows:

A=control channel over a single subframe, A′=control channel over a bundle, where

A1=common search space (CSS), A1′=CSS bundle

A2=UE-specific search space (USS), A2′=USS bundle;

B=unicast data channel over a single subframe, B′=unicast data channel over a bundle;

C=SIB over a single subframe, C′=SIB over a bundle;

D=random access response (RAR) over a single subframe, D′=RAR over a bundle;

E=paging over a single subframe, E′=paging over a bundle;

F=PUCCH transmission over a single subframe, F′=PUCCH transmission over a bundle; and

G=PUSCH transmission over a single subframe, G′=PUSCH transmission over a bundle.

Regarding decoding requirements, the following options for the low-complexity UE can be considered:

Option 1. Only one channel regardless of UL or DL—for example, (A1 or A2 or B or C or D or E or F or G);

Option 2. One channel in UL and one channel in DL—for example, (e.g. A1 or A2 or B or C or D or E)+((A1 or G) or F);

Option 3. One PUSCH in UL and one PDSCH in DL—for example, (A1 or A2)+(B or C or D or E)+(F or G); and

Option 4. One PDCCH/PDSCH in DL and one PDCCH/PUSCH in UL—(A1 or A2)+(B or C or D or E)+(A1 or A2)+(F or G)

For the low-complexity UE with coverage enhancement, two approaches can be considered.

Approach 1) Each option is applied within a bundle. For example, if only one channel can be received in a subframe, only one channel can be received in a bundle. In other words, partial or full overlap between bundled channels is not allowed.

Approach 2) Partial or full overlap of bundled channels is allowed. For example, if the option 1 is applied, even though a control channel and a data channel cannot be received in a subframe within a bundle (e.g. 100 subframes), two channels can be received as long as they do not overlap each other in the same subframe. In other words, time division multiplexing (TDM) among different channels can be allowed. In the subframe where the collision occurs, a UE may select the channel with higher priority.

In addition, the reception/transmission priority among a plurality of potential channels can be summarized as follows.

Alt 1. On-going transmission is always prioritized and single reception (RX) or transmission (TX) is allowed at one time within a bundle. For example, if a UE starts receiving a bundle of control channels, the UE may not receive any other channels until the UE completes the reception of the control channels even though other channels are transmitted during the bundle duration.

Alt 2. On-going transmission is always prioritized and single RX in DL and single TX in UL can be simultaneously handled regardless of HD-FDD, FD-FDD or TDD. Within a bundle, partial or full overlap between RX and TX can be considered.

Alt 3. On-going transmission is always prioritized and single control channel RX and data channel RX in DL and single TX in UL can be simultaneously handled regardless of HD-FDD or FD-FDD or TDD.

Alt 4. On-going transmission is always prioritized and up to two control channel RX (e.g., one for a DL PDSCH and the other for a UL PUSCH) and data channel RX in DL and single TX in UL can be simultaneously handled regardless of HD-FDD, FD-FDD or TDD.

When more than one channel starts at the same subframe, the priority of selection can be as follows.

Selection priority 1: If the UE already receives a control channel, the highest priority is given to scheduled data. For example, if the UE already receives a control channel for an SIB and the SIB and a PDCCH for paging collide in a subframe, PDSCH transmission of the SIB has the higher priority. Similarly, a PUSCH can have higher priority over the control channel. If the UE receives a data channel bundle, the highest priority can be given to the PUCCH transmission. In other words, if collision occurs, a behavior expected from the previous bundle leads the highest priority.

Selection priority 2: Regardless of previous transmission, the priority is given in the following order: RAR>paging>SPS unicast>unicast (control or data)>SIB. This also includes transmission of associated control channels to transmit the data channels. In other words, for example, a control channel for the RAR has higher priority over a control channel for the paging.

Meanwhile, when data is successfully received by a UE after completion of scheduling, the data reception may have priority over reception/transmission of other new data. For example, while a UE continuously receives a PDSCH bundle, the UE may not attempt to receive an SIB bundle. In addition, if the UE starts receiving the SIB bundle, the UE may not attempt to receive a DL control channel (e.g., PDCCH) to receive/transmit new data while receiving the SIB bundle. Alternatively, in a single subframe, the priority may be given in the following order: unicast data (e.g., PDSCH)>SIB>unicast control (e.g., PDCCH). If a UE needs to receive a (unicast) PDSCH in a specific subframe even though an SIB is transmitted in the specific subframe, the UE can receive the (unicast) PDSCH in the specific subframe instead of receiving the SIB. However, if the UE receives the SIB in the specific subframe, the UE may not attempt PDCCH reception or monitoring on a subframe reserved for reception or monitoring of the SIB.

<B. Handling of PDSCHs Overlapping>

Currently, the low-complexity UE is not required to receive more than one PDSCH in a subframe. At this time, when more than one PDSCH overlap, UE behavior needs to be discussed. There may be two cases for PDSCH overlapping. One is that one or more PDSCH bundles overlap so that a UE needs to start receiving a new PDSCH bundle while receiving a PDSCH bundle, and the other one is that transmission of one or more PDSCHs is started in a same subframe so that a UE needs to select one PDSCH to receive. For simplicity, the collision issue can be avoided by an eNB. However, for example, in case of a collision between a unicast PDSCH and a broadcast PDSCH, since the eNB does not know when a UE reads the broadcast PDSCH such as an SIB, collision avoidance only by the eNB may not be easily feasible or efficient. Therefore, it is necessary to define the UE behavior when one or more PDSCHs are transmitted.

Overlapping of PDSCH Bundles

Hereinafter, a (partial) overlapping issue caused by transmission of one or more PDSCH bundles will be discussed.

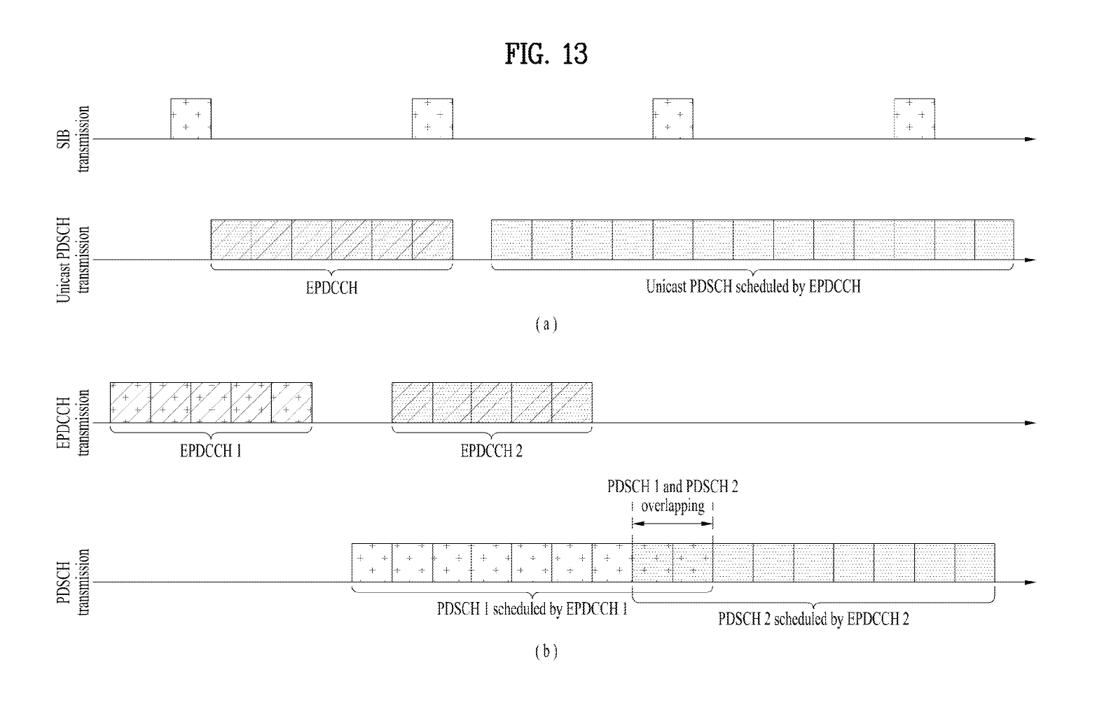

FIG. 13 illustrates processing for overlapping PDSCHs according to embodiments of the present invention.

The overlapping issue caused by transmission of one or more PDSCH bundles can occur when SIB transmission and unicast PDSCH bundle transmission overlap as shown in FIG. 13 (a). In FIG. 13 (a), it is assumed that a SIB bundle is transmitted on discontinuous subframes. In this case, the unicast PDSCH can be scheduled while a UE attempts to receive the SIB. Thus, the UE cannot receive both of the unicast PDSCH and the SIB in the overlapping subframes. In other words, the UE can receive either the unicast PDSCH or the SIB in the overlapping subframes at most.

FIG. 13 (b) shows another case in which two PDSCHs overlap. If a PDSCH is scheduled before transmission of a previous PDSCH bundle is completed, subframes for two PDSCH bundles scheduled by a corresponding EPDCCH may overlap. Then, it is not possible to receive two PDSCHs in the overlapping subframe period.

If overlapping subframes are not many as shown in FIG. 13 (a), a UE may be able to receive more than two PDSCH bundles by receiving one PDSCH in the overlapping subframes. However, in this case, the probability of successful decoding for one PDSCH or both PDSCHs may be degraded. In addition, it may increase the UE complexity and a buffer size. Therefore, it is preferable that when one or more bundles overlap, the UE selects one PDSCH to receive. The following two options can be considered to determine the PDSCH bundle to be received.

Option A: Defining priority among PDSCHs

When two PDSCHs overlap, a priority rule can be defined among the PDSCHs so that a UE can select one PDSCH to receive. First, prioritization among RAR, paging, SIB and unicast PDSCH would be required. For example, considering the importance and receiving opportunity of each PDSCH type, the priority can be given in the following order: RAR>paging>unicast PDSCH>SIB. When the two unicast PDSCH bundles scheduled by the EPDCCH as shown in FIG. 13 (b) overlap, it can be prevented by eNB scheduling or by configuring an EPDCCH transmission period longer than a subframe length of the PDSCH bundle. If these preventing methods are not sufficient, priority can be given to a prior PDSCH bundle among the two PDSCH bundles. In addition, when an SPS PDSCH overlaps with a unicast PDSCH bundle (scheduled by EPDCCH), a priority rule can also be defined. In this case, similar to the legacy priority, the unicast PDSCH bundle (scheduled by EPDCCH) can have priority.

Option B: Giving Priority to PDSCH in Reception

Since the low-complexity UE operating in enhanced coverage may require more time to receive data, data dropped during the reception may be insufficient due to new data with higher priority. To reduce the UE complexity and energy consumption, simple UE behavior can be considered, that is, the priority can be always given to PDSCH reception. Then, a UE does not need to monitor other PDSCHs during receiving a PDSCH bundle. For example, if a UE receives an SIB bundle as shown in FIG. 13 (a), the UE is not required to monitor other PDSCHs even if a unicast PDSCH is scheduled to the UE. Similarly, if two unicast PDSCH bundles are scheduled by an EPDCCH as shown in FIG. 13 (b), the priority is given to a prior PDSCH bundle.

Scheduling of at Least One PDSCH Transmission in a Subframe

Hereinafter, a description will be given of a case in which a UE needs to select one PDSCH to receive because one or more PDSCH (bundle) transmissions are started in a same subframe. The at least one PDSCH (bundle) transmission started in the same subframe can be happened to the low-complexity UE with or without coverage enhancement. For example, two broadcast PDSCHs (or a broadcast PDSCH and a unicast PDSCH) could be scheduled at the same time. Alternatively, when the UE attempts to start SIB bundle reception, PDSCH bundle transmission can be started. In these cases, the UE cannot receive both PDSCHs and should select one PDSCH to receive.

To determine UE behavior when at least one PDSCH (bundle) transmission is started in a same subframe, a priority rule among PDSCHs can be defined. The priority rule can be similar to the option A in the section of ‘Overlapping of PDSCH bundles’. Among RAR, paging, SIB and unicast PDSCH, the priority can be given in the following order: RAR, paging, unicast PDSCH, and SIB. When the unicast PDSCH (scheduled by the EPDCCH) and the SPS PDSCH collide with each other, the priority can be given to the unicast PDSCH bundle (scheduled by the EPDCCH) similar to the legacy priority rule. In addition, if an eNB schedules that one or more EPDCCHs scrambled with the same C-RNTI are not transmitted at the same time, two unicast PDSCH bundles may not be simultaneously scheduled by the EPDCCHs.

<C. Overlap Among DL Transmissions in Coverage Enhancement (CE)>

It is generally expected that broadcast transmission and unicast transmission may be performed on different narrowbands. If the broadcast transmission and the unicast transmission are performed on different narrowbands, a UE with limited UE capability cannot monitor both of the broadcast transmission and the unicast transmission at the same time. In addition, the UE is not required to monitor a plurality of transport blocks for the broadcast and unicast transmission in the same subframe. In this case, the following issues remain unsolved:

Simultaneous reception of a transport block for broadcast transmission and a control channel for unicast in a subframe;

Simultaneous reception of a control channel for broadcast data and a control/data channel for unicast in a subframe;

Simultaneous reception of multiple transport blocks for broadcast and unicast in a bundle;

Simultaneous reception of control/data of broadcast and control/data of another broadcast channel in a bundle window;

Simultaneous reception of control/data of broadcast and control/data of unicast in a bundle window; and

Simultaneous reception of control/data of unicast transmission in a bundle window.

Here, a bundle window means duration between start and end points of repetition of one channel. For example, if a unicast PDSCH repeats 100 times over 250 ms, a bundle window means duration of 250 ms. Considering MBSFN subframes and the like, it may take more time than 100 ms to complete 100 times repetition.

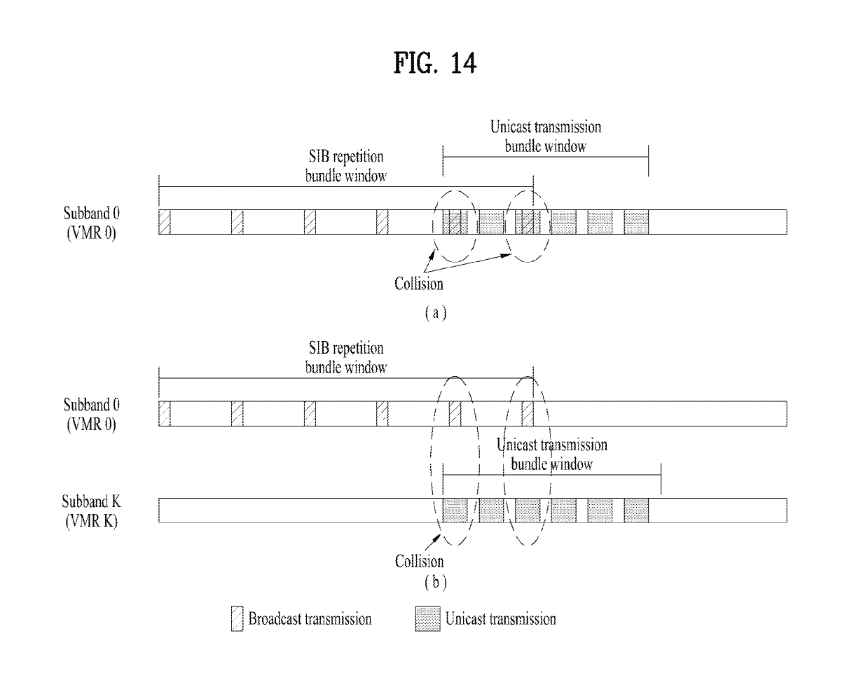

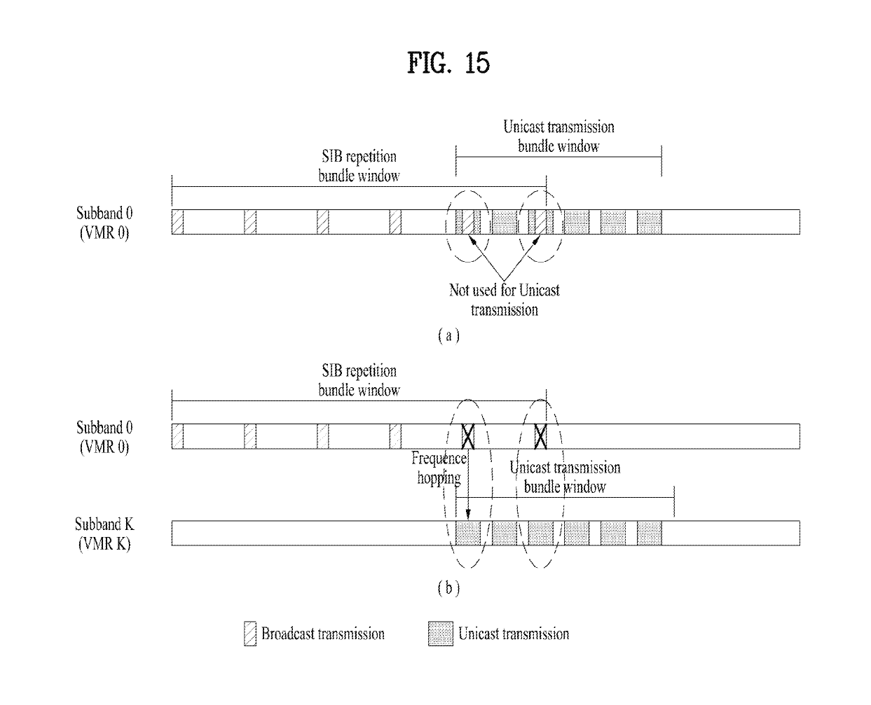

FIG. 14 illustrates channel collisions that can occur in a same narrowband or different narrowbands. Specifically, FIG. 14 (a) illustrates a case (hereinafter referred to as case 1) in which unicast and broadcast collide in a same sub-band and FIG. 14 (b) illustrates a case (hereinafter referred to as case 2) in which unicast and broadcast collide in different sub-bands. Meanwhile, FIG. 15 illustrates methods of solving a collision between channels according to embodiments of the present invention. Specifically, FIG. 15 (a) shows an example of a collision solution for the case 1 and FIG. 15 (b) shows an example of collision solution for the case 2.

Assuming that a UE is not capable of monitoring more than one narrowband at one time, collision cases include a case where the same resources collide between two channels in the same subframe and a case where different resources collide between two channels in the same subframe. In this case, a network may not know whether the collision has been occurred or not completely unless explicit TDM is used between broadcast and unicast transmission for both control and data channels or between broadcast transmissions. However, disjoint TDM can become very inefficient and may not be feasible. For example, in TDD with limited DL subframes and MBSFN subframes, if some subframes are reserved for broadcast transmissions, the number of subframes for unicast repetition may not be sufficient. In addition, if there are many MTC UEs and a very limited number of legacy UEs, the disjoint TDM could be significantly inefficient in terms of resource utilization. Thus, disjoint time allocation between broadcast and unicast and between broadcast channels cannot be easily assumed. Moreover, a set of intended subframes used by a UE to monitor broadcast channels may not be easily indicated. For example, when a PRACH is triggered, collision avoidance via UE assistance between RAR and unicast transmission or RAR and another broadcast is not easily implemented. Thus, Alt 3 alone may not be sufficient to handle the collision issues.

First, some beneficial priority rules can be established between Alt 1 and Alt 2. Particularly, the priority can be beneficial to the following use cases:

RAR and unicast or SIB reception: Since a UE can transmit a PRACH for the purpose of SR, RAR transmission and unicast or SIB transmission can overlap in a bundle window for RAR, unicast or SIB transmission. In this case, since failure of reception of the RAR leads another PRACH transmission and SIB reception can be on standby, it is desirable to give higher priority to the RAR.

SIB monitoring and unicast reception: since unicast is already scheduled and the network assumes that uncast reception is not affected by an SIB (with SIB update), it is possible to assume that the unicast reception has higher priority over the SIB monitoring.

Paging and unicast reception: If a UE is in RRC_CONNECTED mode, the UE will monitor paging mainly to acquire SI update indication. However, the use of the paging for SI update for UEs in the connected mode may be extremely inefficient in terms of resources and power consumption. Thus, the SI update should be partially improved such that the paging may not need to be monitored when the UE is in the RRC_CONNECTED mode.

For all cases, unicast reception may include both control and data channels. If control for one channel and data for the other channel are transmitted simultaneously in the same narrowband, a UE may support simultaneous reception of control and data in the same subframe. However, this may increase overall complexity of UE processing and thus, further research on performance gain and complexity would be necessary. That is, the following proposals can be considered to solve the collision issues.

Proposal 1: Priority rules can be defined to handle the overlapping issue. In an embodiment of the present invention, the priority is given in the following order: RAR>unicast>SIB.

Proposal 2: SI update enhancement can be considered to eliminate the necessity of paging monitoring in RRC_CONNECTED mode.

Proposal 3: If there is no significant gain, it is assumed that a UE in coverage enhancement mode is not required to receive control channels for one transport block and another transport block in the same subframe. In other words, the UE is not required to simultaneously receive a control channel (e.g., PDCCH) and a data channel (e.g., PDSCH) in the same frame.

Another issue is whether a UE is expected to receive one or more transport blocks in a bundle window. For example, if a UE supports one or more HARQ processes, it is possible to consider the possibility of utilizing multiple HARQ processes simultaneously. If a UE needs to wait an entire bundle window for one transport block for another transport block with a different HARQ process ID, depending on HARQ-ACK timing and the number of repetitions used for a PUCCH, the number of possible parallel HARQ processes can be limited. In this case, some design can be considered to effectively use the multiple HARQ processes. For example, interlaced repetition between transport blocks with different HARQ process IDs can be allowed to increase the number of parallel HARQ processes. For instance, when a bundle of PDSCHs (hereinafter referred to as a PDSCH bundle) is transmitted in N consecutive subframes, after completion of transmission of a PDSCH bundle for HARQ process 1, a PDSCH bundle for HARQ process 2 is transmitted. In this case, an eNB can receive ACK/NACK information in response to the HARQ process 1 at timing when HARQ process 3 is transmitted and thus reuse a HARQ process ID set to 1 (or retransmit the PDSCH bundle for the HARQ process 1). That is, even if there are 8 HARQ processes as in the related art, the eNB cannot use all of the 8 HARQ processes. To allow the eNB to use many HARQ processes at the same time, PDSCHs with different HARQ process IDs need to be simultaneously transmitted. To this end, a plurality of interlaced PDSCH bundles should be transmitted.

Overlap in Case 1 (cf. FIG. 14 (a))

Frequency hopping can be used for both unicast and broadcast transmission and use of a cell-common hopping pattern for narrowband switching can be considered. In an embodiment of the present invention, it is proposed that a UE is configured with a virtual narrowband index where the UE can expect transmission of unicast control/data. In addition, separate virtual narrowband can be assigned for broadcast and unicast narrowband may or may not overlap with narrowband(s) used for the broadcast. If resources overlap each other, available DL subframes in which a UE can expect unicast transmission need to be clarified because the UE may not monitor broadcast data in some cases. In other words, the UE may not know whether broadcast has been scheduled. Particularly, if the UE shares the same narrowband with RAR transmission, the UE does not know whether RAR transmission to other UEs occurs. Thus, it is difficult to assume which subframes can be used for the unicast transmission in general. To mitigate this issue, it is possible to consider network assistance to indicate a set of subframes available for unicast repetition. Such network assistance can be applied to both control and data repetition. To this end, proposal 4 below can also be considered besides the aforementioned proposals 1 to 3.

Proposal 4: When it is expected that broadcast and unicast occur in a same subframe, indication of a set of subframes available for unicast repetition is considered

When the proposal 4 is applied and the same narrowband is used, a UE may not expect to receive unicast transmission in subframes where broadcast transmission can potentially occur as shown in FIG. 15 (a). Since this may reduce the number of subframes available for repetition, it can increase the overall latency of data reception. Thus, it is preferred that separate narrowbands are configured for unicast and broadcast transmission.

Overlap in Case 2 (cf. FIG. 14 (b))

If different narrowbands are used for unicast and broadcast, two channels may collide with each other only when a UE needs to read broadcast transmission (e.g., SIB and RAR). As described above, in this case, the priority is given and the UE can perform monitoring as shown in FIG. 15 (b). Moreover, the UE can switch narrowband(s) to monitor higher-priority channel(s) based on the priority. In this case, a gap for frequency hopping may be considered. Since the gap for frequency hopping causes performance degradation of unicast transmission, the network may avoid scheduling of the unicast transmission while updating SIB(s).

<D. Overlap Issue in Normal Coverage>

Overlap Issue Among DL Transmissions in Normal Coverage (NC)

In this specification, NC means that a channel is transmitted in a single subframe (without repetition) unlike coverage enhancement where a channel is repeatedly transmitted in a plurality of subframes.

Since a low-complexity UE can monitor only one narrowband at a time, there may be a collision issue between a channel in subframe n at narrowband m and another channel in subframe n+1 at narrowband K.

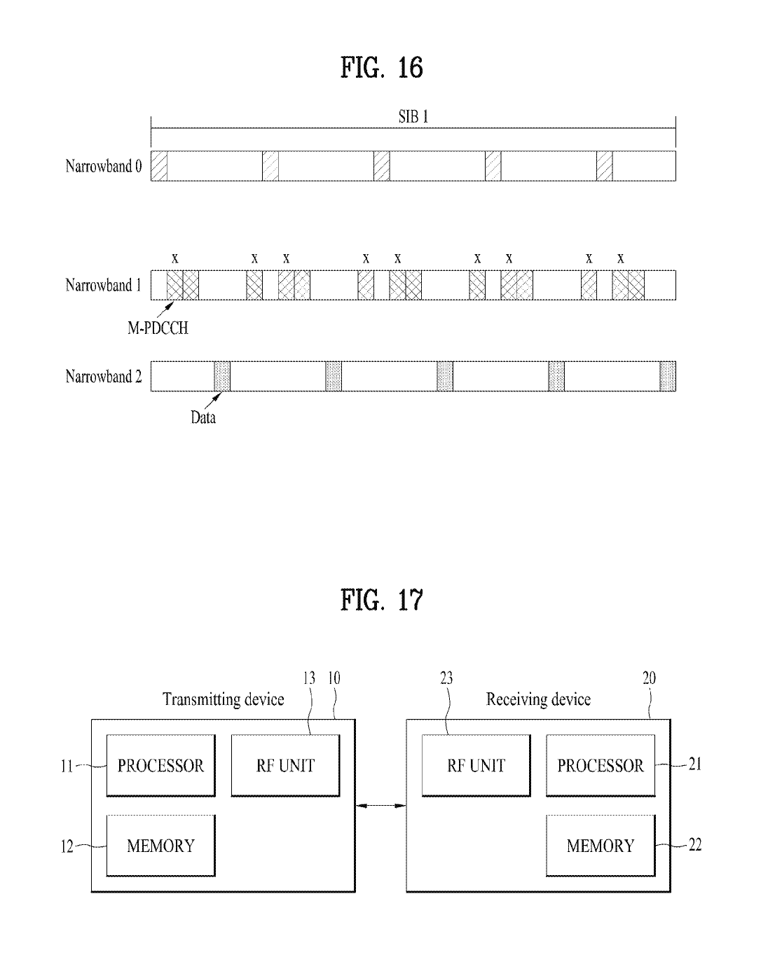

FIG. 16 illustrates a collision between two subframes for two channels.

Referring to FIG. 16, SIB1 may collide with an M-PDCCH. In addition, if a UE needs to read the SIB1, the M-PDCCH may not be monitored. The priority rule for the coverage enhancement (CE) can be applied for normal coverage between subframes n and n+1. If a higher-priority channel is transmitted in the subframe n+1 and the UE requires a retuning gap of 1 ms, the UE can use the subframe n as the gap and not monitor a channel in the subframe n. For example, if the subframe n is for a PDSCH and the subframe n+1 is for potential RAR reception and if an RAR has higher priority over unicast, the PDSCH can be dropped in the subframe n. In other words, the UE can drop PDSCH reception. Eventually, proposal 5 below can be considered.

Proposal 5: If a frequency retuning gap is needed, priority similar to that in CE overlap is applied to NC for collisions across adjacent subframes

Overlap Among UL Transmissions in NC

In UL, there are PRACH, PUCCH, PUSCH and SRS transmissions. Since some transmissions may be configured to be transmitted periodically whereas other transmissions may be scheduled dynamically, there may be collisions between channels in the same subframe or adjacent subframes. In this case, transmission narrowband resources may be different. For example, according to a periodic CSI configuration, if a PUCCH is scheduled to be transmitted in subframe n and the network grants a PUSCH in subframe n−4, a collision may occur between the PUCCH and PUSCH. Although it is desirable to avoid this situation, in some cases, for example, if the network desires to receive aperiodic CSI feedback instead of periodic CSI, the network can schedule a UL grant which can have higher priority over periodically configured transmissions. If the PUCCH and PUSCH are transmitted in the same subframe, priority among colliding channels can be determined based on UCI types. In general, the priority can be given in the following order: HARQ-ACK=SR>aperiodic CSI (hereinafter abbreviated as apCSI)>aperiodic SRS (hereinafter abbreviated as apSRS)>UL-grant PUSCH>SPS PUSCH>periodic CSI (hereinafter abbreviated as pCSI)>periodic SRS (hereinafter abbreviated as pSRS). Here, the UL-grant PDSCH means a PUSCH scheduled by a UL grant (through a (E)PDCCH). The above-described priority rule can be applied to a case in which a channel scheduled in subframe n and another channel scheduled in subframe n+1 need to be transmitted. In summary, proposal 6 below can be considered.

Proposal 6: Priority among UL channels colliding at different narrowbands in the same subframe, i.e., priority among UL channels to be transmitted is determined. If a frequency retuning gap is needed, priority among UL channels scheduled at different narrowbands over adjacent subframes is also determined.

Overlap Among DL and UL Transmissions in NC for HD-FDD

According to current UE operation in the HD-FDD, a UE creates an autonomous gap before and after UL transmission. For example, for type-A HD-FDD operation, a legacy UE does not receive the last portion of a DL subframe immediately before a UL subframe of the UE to generate a guard period. As another example, for type-B HD-FDD operation, a legacy UE does not receive a DL subframe immediately before a UL subframe of the UE to generate a guard period. This may imply that in the conventional HD-FDD, UL transmission is higher priority over DL reception. However, if a UE is configured to perform CSI and SRS transmission which will create multiple retuning gaps and reduce the number of DL receptions, the current UE operation in the HD-FDD may become inefficient. Considering the above discussion, an embodiment of the present invention proposes to apply priority in the TDD, which will be described later, to the HD-FDD in a similar manner.

Overlap Among UL and DL Transmissions in NC for TDD

Currently, since a UL timing advance (TA) can compensate latency caused by switching from UL to DL, there is no gap from UL to DL in the TDD. In case a low-complexity UE operates in a narrowband, if a narrowband center frequency of a UL subframe (SF) (e.g., SF n) is different from that of a DL SF (e.g., SF n+1), a frequency retuning gap between two narrowbands may be required even in the TDD. In this case, it is desirable to have the retuning gap between switching from UL to DL. In addition, gap processing may depend on the frequency retuning gap. In the conventional TDD, since the UL center frequency is the same as the DL center frequency, a gap for switching between DL and UL operations is required rather than frequency retuning. However, in the case of MTC operating in a narrowband, since UL and DL narrowband positions in the system bandwidth may be different from each other even in the TDD, not only a time for the switching between DL and UL operations but also a time for the frequency retuning may be required. In addition, since it is expected that the time for the frequency retuning is generally greater than the time for the switching between DL an UL operations, for ‘switching between UL and DL+frequency retuning’, the MTC TDD may require a UL and DL switching gap which is greater than that in the conventional TDD. Moreover, in the HD-FDD, since two oscillators are used for UL and DL frequency matching, the legacy UE does not need to perform the frequency retuning in the case of switching between UL and DL (UL<->DL). However, in the case of a low-cost HD-FDD UE, since a single oscillator is used to reduce the cost, a frequency retuning time of up to 1 ms may be required for UL<->DL switching. Assuming that the gap or frequency retuning time is 1 ms, either subframe n or n+1 may be used for the gap. When different channels are transmitted in the subframes n and n+1, which subframe is used for the gap or frequency retuning time may be determined according to the channel scheduled in each subframe. For example, dynamically scheduled transmission may have higher priority over periodically scheduled transmission, that is, a dynamically scheduled PDSCH has higher priority over pCSI. In this case, priority can be given in the following order: PRACH or SR or HARQ-ACK or UCI (e.g., apCSI, apSRS, etc.) triggered by the network (e.g., eNB)>PUSCH>DL data>M-PDCCH. Further, proposal 8 below can be considered.

Proposal 8: If a frequency retuning gap is needed, a priority rule between DL and UL channels to be scheduled in adjacent subframes in TDD is defined.

<E. Collision Issue in HD-FDD and TDD>

In the HD-FDD or TDD environment, a UE cannot simultaneously perform UL transmission and DL reception. In addition, in the HD-FDD environment, a guard period of up to 1 ms is required to switch from UL to DL or from DL to UL. In the current TDD environment, DL to UL switching is performed using a guard period in a special subframe only. On the other hand, UL to DL switching is performed using a time interval between a transmission end time of a UL subframe and a reception time of a DL subframe without a separate guard period. However, in the case of an MTC UE with reduced bandwidth (e.g., 6 RBs), if DL and UL operating frequencies are dynamically changed, the MTC UE may require a guard period of up to 1 ms for switching from UL to DL and vice versa even in the TDD environment.

PDSCH and PUSCH

In the HD-FDD or TDD environment, a PDSCH and/or PUSCH (hereinafter referred to as PDSCH/PUSCH) may be scheduled for an MTC UE with or without the coverage enhancement through cross-subframe scheduling and then the PDSCH/PUSCH can be received by the MTC UE. For example, the PDSCH may be scheduled in subframe #n through an EPDCCH and the scheduled PDSCH may be received in subframe #n+k1. In addition, the PUSCH may be scheduled in subframe #n through an EPDCCH and the scheduled PUSCH may be transmitted in subframe #n+k2.

In this case, there may be a problem that if the PDSCH and PUSCH are scheduled in a same subframe, the UE cannot perform PDSCH reception and PUSCH transmission at the same time. In addition, the PDSCH and PUSCH, which are scheduled by EPDCCHs in different subframes, may be scheduled in adjacent subframes. For example, there may be a situation in which the PDSCH is transmitted in subframe #m and the PUSCH is transmitted in subframe #m+1. In this situation, the UE cannot simultaneously perform the PDSCH reception and the PUSCH transmission due to the guard period (e.g., guard subframe) for DL to UL switching or UL to DL switching. Therefore, the present invention proposes that when a UE cannot simultaneously perform PDSCH reception and PUSCH transmission due to a guard period, the UE operates according to the following priority rules.

Method 1. Transmission/reception of data (PDSCH or PUSCH) to be transmitted/received first has higher priority. For example, if a UE needs to receive a PDSCH in subframe #m and transmit a PUSCH in subframe #m+1, the UE may perform PDSCH reception to be performed first and drop PUSCH transmission.

Method 2. Transmission/reception of data (PDSCH or PUSCH) to be transmitted/received later has higher priority. For example, if a UE needs to receive a PDSCH in subframe #m and transmit a PUSCH in subframe #m+1, the UE may perform PUSCH transmission to be performed later and drop PDSCH transmission.

Method 3. Transmission/reception of first scheduled data (PDSCH or PUSCH) has higher priority. If a UE needs to transmit a PUSCH, which is scheduled through an EPDCCH transmitted in subframe #n, in subframe #m+1 and receive a PDSCH, which is scheduled through an EPDCCH transmitted in subframe #n+a, in subframe #m, the UE may perform PUSCH transmission scheduled through the early transmitted EPDCCH and drop PDSCH reception.

Method 4. Transmission/reception of later scheduled data (PDSCH or PUSCH) has higher priority. If a UE needs to transmit a PUSCH, which is scheduled through an EPDCCH transmitted in subframe #n, in subframe #m+1 and receive a PDSCH, which is scheduled through an EPDCCH transmitted in subframe #n+a, in subframe #m, the UE may perform PDSCH reception scheduled through the later transmitted EPDCCH and drop PUSCH transmission.

Method 5. PDSCH reception scheduled to a UE has priority over PUSCH transmission.

Method 6. PUSCH transmission has priority over PDSCH reception.

SIB and PUSCH

In the HD-FDD or TDD environment, SIB reception may need to be performed on a subframe corresponding to PUSCH transmission timing, a guard period (e.g., guard subframe) in which DL to UL switching is performed for PUSCH transmission, or a guard period (e.g., guard subframe) in which a UE performs UL to DL switching for DL reception after PUSCH transmission (by receiving system information update). In this case, the present invention proposes that a UE operates according to the following priority rules.

Method 1. PUSCH transmission scheduled to a UE has priority over SIB reception. For example, in case a UE is scheduled to transmit a PUSCH in subframe #m, if an SIB is transmitted in subframe #m−1, subframe #m or subframe #m+1, the UE may perform PUSCH transmission on the subframe #m without receiving the SIB.

Method 2. SIB reception has priority over PUSCH transmission. For example, in case a UE is scheduled to transmit a PUSCH in subframe #m, if an SIB is transmitted in subframe #m−1, subframe #m or subframe #m+1, the UE may perform SIB reception and drop PUSCH transmission in the subframe #m.

SPS PDSCH and PUSCH

In the HD-FDD or TDD environment, SPS PDSCH reception may need to be performed on a subframe corresponding to PUSCH transmission timing, a guard period (e.g., guard subframe) in which a UE performs DL to UL switching for PUSCH transmission, or a guard period (e.g., guard subframe) in which a UE performs UL to DL switching for DL reception after PUSCH transmission. In this case, the present invention proposes that a UE operates according to the following priority rules.

Method 1. PUSCH transmission scheduled to a UE has priority over SPS PDSCH reception. For example, in case a UE is scheduled to transmit a PUSCH in subframe #m, if an SPS PDSCH is transmitted in subframe #m−1, subframe #m or subframe #m+1, the UE may perform PUSCH transmission on the subframe #m without receiving the SPS PDSCH.

Method 2. SPS PDSCH reception has priority over PUSCH transmission. For example, in case a UE is scheduled to transmit a PUSCH in subframe #m, if an SPS PDSCH is transmitted in subframe #m−1, subframe #m or subframe #m+1, the UE may perform SPS PDSCH reception and drop PUSCH transmission in the subframe #m.

PDSCH and PUCCH

In the HD-FDD or TDD environment, PDSCH reception can be scheduled in a subframe in which a PUCCH for ACK/NACK transmission is transmitted, a guard period (e.g., guard subframe) in which a UE performs DL to UL switching to transmit the PUCCH for ACK/NACK transmission, or a guard period (e.g., guard subframe) in which a UE performs UL to DL switching for DL reception after PUSCH transmission. In this case, the present invention proposes that a UE operates according to the following priority rules.

Method 1. PDSCH reception scheduled to a UE has priority over PUCCH transmission. For example, if a UE is scheduled to receive a PDSCH in subframe #m and needs to transmit a PUCCH in subframe #m−1, subframe #m or subframe #m+1, the UE may perform PDSCH reception without performing PUCCH transmission.

Method 2. PUCCH transmission has priority over PDSCH reception scheduled to a UE. For example, if a UE is scheduled to receive a PDSCH in subframe #m and needs to transmit a PUCCH in subframe #m−1, subframe #m or subframe #m+1, the UE may perform PUCCH transmission without performing PDSCH reception.

SIB and PUCCH

In the HD-FDD or TDD environment, SIB reception may need to be performed on a subframe in which a PUCCH for ACK/NACK transmission is transmitted, a guard period (e.g., guard subframe) in which a UE performs DL to UL switching to transmit the PUCCH for ACK/NACK transmission, or a guard period (e.g., guard subframe) in which a UE performs UL to DL switching for DL reception after PUSCH transmission. In this case, the present invention proposes that a UE operates according to the following priority rules.

Method 1. SIB reception has priority over PUCCH transmission. For example, if an SIB is transmitted in subframe #m and a UE needs to transmit a PUCCH in subframe #m−1, subframe #m or subframe #m+1, the UE may perform SIB reception without performing PUCCH transmission.

Method 2. PUCCH transmission has priority over SIB reception. For example, if an SIB is transmitted in subframe #m and a UE needs to transmit a PUCCH in subframe #m−1, subframe #m or subframe #m+1, the UE may perform PUCCH transmission without performing SIB reception.
SPS PDSCH and PUCCH

In the HD-FDD or TDD environment, SPS PDSCH may need to be performed on a subframe in which a PUCCH for ACK/NACK transmission is transmitted, a guard period (e.g., guard subframe) in which a UE performs DL to UL switching to transmit the PUCCH for ACK/NACK transmission, or a guard period (e.g., guard subframe) in which a UE performs UL to DL switching for DL reception after PUSCH transmission. In this case, the present invention proposes that a UE operates according to the following priority rules.

Method 1. SPS PDSCH reception has priority over PUCCH transmission. For example, if an SPS PDSCH is transmitted in subframe #m and a UE needs to transmit a PUCCH in subframe #m−1, subframe #m or subframe #m+1, the UE may perform SPS PDSCH reception without performing PUCCH transmission.

Method 2. PUCCH transmission has priority over SPS PDSCH reception. For example, if an SPS PDSCH is transmitted in subframe #m and a UE needs to transmit a PUCCH in subframe #m−1, subframe #m or subframe #m+1, the UE may perform PUCCH transmission without performing SPS PDSCH reception.

Further, the above-described embodiments and/or proposals according to the present invention can be applied independently or at least two embodiments and/or proposals can be applied together.

FIG. 17 is a block diagram illustrating elements of a transmitting device 10 and a receiving device 20 for implementing the present invention.

The transmitting device 10 and the receiving device 20 respectively include Radio Frequency (RF) units 13 and 23 capable of transmitting and receiving radio signals carrying information, data, signals, and/or messages, memories 12 and 22 for storing information related to communication in a wireless communication system, and processors 11 and 21 operationally connected to elements such as the RF units 13 and 23 and the memories 12 and 22 to control the elements and configured to control the memories 12 and 22 and/or the RF units 13 and 23 so that a corresponding device may perform at least one of the above-described embodiments of the present invention.

The memories 12 and 22 may store programs for processing and controlling the processors 11 and 21 and may temporarily store input/output information. The memories 12 and 22 may be used as buffers.

The processors 11 and 21 generally control the overall operation of various modules in the transmitting device and the receiving device. Especially, the processors 11 and 21 may perform various control functions to implement the present invention. The processors 11 and 21 may be referred to as controllers, microcontrollers, microprocessors, or microcomputers. The processors 11 and 21 may be implemented by hardware, firmware, software, or a combination thereof. In a hardware configuration, application specific integrated circuits (ASICs), digital signal processors (DSPs), digital signal processing devices (DSPDs), programmable logic devices (PLDs), or field programmable gate arrays (FPGAs) may be included in the processors 11 and 21. Meanwhile, if the present invention is implemented using firmware or software, the firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

The processor 11 of the transmitting device 10 performs predetermined coding and modulation for a signal and/or data scheduled to be transmitted to the outside by the processor 11 or a scheduler connected with the processor 11, and then transfers the coded and modulated data to the RF unit 13. For example, the processor 11 converts a data stream to be transmitted into K layers through demultiplexing, channel coding, scrambling, and modulation. The coded data stream is also referred to as a codeword and is equivalent to a transport block which is a data block provided by a MAC layer. One transport block (TB) is coded into one codeword and each codeword is transmitted to the receiving device in the form of one or more layers. For frequency up-conversion, the RF unit 13 may include an oscillator. The RF unit 13 may include Nₜ (where Nₜ is a positive integer) transmit antennas.

A signal processing process of the receiving device 20 is the reverse of the signal processing process of the transmitting device 10. Under control of the processor 21, the RF unit 23 of the receiving device 20 receives radio signals transmitted by the transmitting device 10. The RF unit 23 may include Nᵣ (where Nᵣ is a positive integer) receive antennas and frequency down-converts each signal received through receive antennas into a baseband signal. The processor 21 decodes and demodulates the radio signals received through the receive antennas and restores data that the transmitting device 10 intended to transmit.

The RF units 13 and 23 include one or more antennas. An antenna performs a function for transmitting signals processed by the RF units 13 and 23 to the exterior or receiving radio signals from the exterior to transfer the radio signals to the RF units 13 and 23. The antenna may also be called an antenna port. Each antenna may correspond to one physical antenna or may be configured by a combination of more than one physical antenna element. The signal transmitted from each antenna cannot be further deconstructed by the receiving device 20. An RS transmitted through a corresponding antenna defines an antenna from the view point of the receiving device 20 and enables the receiving device 20 to derive channel estimation for the antenna, irrespective of whether the channel represents a single radio channel from one physical antenna or a composite channel from a plurality of physical antenna elements including the antenna. That is, an antenna is defined such that a channel carrying a symbol of the antenna can be obtained from a channel carrying another symbol of the same antenna. An RF unit supporting a MIMO function of transmitting and receiving data using a plurality of antennas may be connected to two or more antennas.

In the embodiments of the present invention, a UE operates as the transmitting device 10 in UL and as the receiving device 20 in DL. In the embodiments of the present invention, an eNB operates as the receiving device 20 in UL and as the transmitting device 10 in DL. Hereinafter, a processor, an RF unit, and a memory included in the UE will be referred to as a UE processor, a UE RF unit, and a UE memory, respectively, and a processor, an RF unit, and a memory included in the eNB will be referred to as an eNB processor, an eNB RF unit, and an eNB memory, respectively.

The eNB processor can control the eNB RF unit to transmit DL control/data signals according to any one of the embodiments of the present invention. In addition, the eNB processor can control the eNB RF unit to receive UL control/data signals according to any one of the embodiments of the present invention. Moreover, the eNB processor can recognize that a UE will drop at least one of a plurality of channels which collide with each other in a single subframe or are scheduled in two adjacent subframes according to any one of the embodiments of the present invention and control the eNB RF unit not to receive or transmit the channel that will be dropped by the UE. Furthermore, the eNB processor can control the eNB RF unit to receive or transmit a non-dropped channel in the corresponding subframe(s). Further, the eNB processor can assume that the plurality of channels will be dropped based on the priority according to any one of the embodiment of the present invention.

The UE processor can control the UE RF unit to receive DL control/data signals according to any one of the embodiments of the present invention. In addition, the UE processor can control the UE RF unit to transmit UL control/data signals according to any one of the embodiments of the present invention. Moreover, the UE processor can control the UE RF unit to drop at least one of a plurality of channels which collide with each other in a single subframe or are scheduled in two adjacent subframes according to any one of the embodiments of the present invention. Furthermore, the UE processor can control the UE RF unit to transmit a non-dropped channel in the corresponding subframe(s). In this case, the plurality of channels can be dropped based on the priority according to any one of the embodiment of the present invention.

As described above, the detailed description of the preferred embodiments of the present invention has been given to enable those skilled in the art to implement and practice the invention. Although the invention has been described with reference to exemplary embodiments, those skilled in the art will appreciate that various modifications and variations can be made in the present invention without departing from the spirit or scope of the invention described in the appended claims. Accordingly, the invention should not be limited to the specific embodiments described herein, but should be accorded the broadest scope consistent with the principles and novel features disclosed herein.

### INDUSTRIAL APPLICABILITY

The embodiments of the present invention are applicable to a BS, a UE, or other devices in a wireless communication system.

1. A method for receiving a signal, the method performed by a user equipment (UE) and comprising:
receiving first information for configuring uplink transmission;
receiving second information for configuring downlink reception; and
performing the uplink transmission based on the first information or performing the downlink reception based on the second information,
wherein if the UE is in half duplex frequency division duplex (HD-FDD) mode, if the uplink transmission and the downlink reception are to be performed in a same subframe or adjacent subframes and if the uplink transmission is configured to be periodic and the downlink reception is scheduled dynamically, the uplink transmission is dropped and the downlink reception is performed.

2. The method of claim 1, wherein the second information is received through a physical downlink control channel (PDCCH) and wherein the downlink reception is performed through a physical downlink shared channel (PDSCH).

3. The method of claim 1, wherein the uplink transmission is periodic channel state information (CSI) reporting.

4. The method of claim 1, wherein either the uplink transmission or the downlink reception is performed in the following priority order: physical random access channel (PRACH), scheduling request (SR), acknowledgement/negative-acknowledgement (ACK/NACK), aperiodic channel state information (CSI), or aperiodic sounding reference signal (SRS)>physical uplink shared channel (PUSCH)>downlink data>enhanced physical downlink control channel (EPDCCH).

5. The method of claim 1, wherein the uplink transmission is performed through a PUSCH.

6. A user equipment (UE) for receiving a signal,
the UE comprising:
a radio frequency (RF) unit; and
a processor configured to control the RF unit, wherein the processor is configured to:
control the RF unit to receive first information for configuring uplink transmission;
control the RF unit to receive second information for configuring downlink reception; and
control the RF unit to perform the uplink transmission based on the first information or the downlink reception based on the second information, and
wherein if the UE is in half duplex frequency division duplex (HD-FDD), if the uplink transmission and the downlink reception are to be performed in a same subframe or adjacent subframes and if the uplink transmission is configured to be periodic and the downlink reception is scheduled dynamically, the processor is configured to control the RF unit to drop the uplink transmission and perform the downlink reception.

7. The UE of claim 6, wherein the second information is received through a physical downlink control channel (PDCCH) and wherein the downlink reception is performed through a physical downlink shared channel (PDSCH).

8. The UE of claim 6, wherein the uplink transmission is periodic channel state information (CSI) reporting.

9. The UE of claim 6, either the uplink transmission or the downlink reception is performed in the following priority order: physical random access channel (PRACH), scheduling request (SR), acknowledgement/negative-acknowledgement (ACK/NACK), aperiodic channel state information (CSI), or aperiodic sounding reference signal (SRS)>physical uplink shared channel (PUSCH)>downlink data>enhanced physical downlink control channel (EPDCCH).

10. The UE of claim 6, wherein the uplink transmission is performed through a PUSCH.

11. A method for transmitting a signal to a user equipment (UE), the method performed by an evolved node B (eNB) and comprising:
transmitting first information for configuring uplink reception;
transmitting second information for configuring downlink transmission; and
performing the uplink transmission from the UE based on the first information or the downlink transmission to the UE using based on the second information,
wherein if the UE is in half duplex frequency division duplex (HD-FDD), if the uplink reception and the downlink transmission are to be performed in a same subframe or adjacent subframes and if the uplink transmission is configured to be periodic and downlink reception is scheduled dynamically, the uplink reception is dropped and the downlink transmission is performed.

12. An evolved node B (eNB) for transmitting a signal to a user equipment (UE), the eNB comprising:
a radio frequency (RF) unit; and
a processor configured to control the RF unit, wherein the processor is configured to:
control the RF unit to transmit first information for configuring uplink reception;
control the RF unit to transmit second information for configuring downlink transmission; and
control the RF unit to perform the uplink reception from the UE based on the first information or the downlink transmission to the UE based on the second information, and
wherein if the UE is in half duplex frequency division duplex (HD-FDD), if the uplink reception and the downlink transmission are to be performed in a same subframe or adjacent subframes and if the uplink reception is configured to be periodic and the downlink transmission is scheduled dynamically, the processor is configured to control the RF unit to drop the uplink reception and perform the downlink transmission.
